(19) United States
(12) Patent Application Publication
(10) Pub. No.: US 2015/0310446 A1
(43) Pub. Date: Oct. 29, 2015

(54) Method and System for Providing Support Services Using Interactive Media Documents

(71) Applicants: Kenneth D. TUCHMAN, Englewood, CO (US); Bruce A. SHARPE, Aurora, CO (US); Henry D. TRUONG, Chelmsford, MA (US)

(72) Inventors: Kenneth D. TUCHMAN, Englewood, CO (US); Bruce A. SHARPE, Aurora, CO (US); Henry D. TRUONG, Chelmsford, MA (US)

(21) Appl. No.: 14/263,892

(22) Filed: Apr. 28, 2014

(51) Int. Cl. G06Q 30/00; G06F 17/30; H04L 29/08

(52) U.S. Cl. CPC G06Q 30/016; H04L 67/02; H04L 67/10; G06F 17/30997

(57) ABSTRACT

According to one embodiment, in response to a user document received from a client, an interactive media document is fabricated based on the user document, including embedding one or more controls in the interactive media document and adding additional information in the interactive media document based on information obtained from a backend system of the client. The controls, when activated from the interactive media, transmit a request to the support center for obtaining support services. The interactive media document is sent to a user on behalf of the client. In response to the request from the user for obtaining support services concerning content of the user document, a live communications session is established between the user and a support agent associated with the support center, including routing data between the user and the support agent via the interactive media document.

### FIELD OF THE INVENTION

Embodiments of the present invention relate generally to a support center for providing support services on products and services on behalf of goods and service providers. More particularly, embodiments of the invention relate to techniques for providing support services using interactive media documents.

### BACKGROUND

Prior to the advent and prolific use of distributed network environments such as the Internet, customer service sessions typically occurred over a teleconference between a customer service agent or service specialist and a customer. These teleconferences, which incidentally are still very popular today, are initiated by a customer placing a phone call to a customer service agent. The customer service agent's phone receives the call through a public-switched telephone network (PSTN). Many support centers handle a large volume of inquiries, usually by phone, for sales, information, customer support and other services. Typical support centers provide the ability to route multiple incoming, customer-initiated calls to agents which provide sales, information, or support on behalf of an entity interested in establishing or maintaining a relationship with the customer.

Modern support center systems selectively route incoming calls based on a number of factors such as the number called or dialed, the originating number, the queued sequence of the caller, the geographic location of the caller, accumulated caller history, and other relevant criteria. Once the system has evaluated the inbound caller's information, if any, the system searches for an available agent to service the call. Availability of agents may be dependent on any number of factors such as a skill area, level of that skill and/or a schedule of the agent. The number of agents within the contact center and available to the system may often be limited by the physical space available for the agents to operate. Contact centers have to deal with a limited number of agents to handle a large number of incoming customer calls. Typically, when an end user initiates a contact with the support center, the end user has to know or maintain the detailed information regarding how to reach people and/or obtain services from the support center.

In some situations, support services provided to a user are often related to a document, such as an invoice, a monthly statement, etc., which the user received from a product or service provider. When the user attempts to contact a support center concerning the received document, the user has to call in an 800 number or send an email to an email address listed in the document separately. Such required efforts may discourage a customer from obtaining support services which may lead to poor customer satisfaction.

Today media sent from one party to another may have some preferred actions embedded (e.g., an information flyer with a “Contact Us” button, a bill with a “Pay Me” button). This media, however, does not link the meta-data associated with the unique piece media and unique customer and connect this data to relevant potential actions. For example, in the case where the piece of media was a customer's bill, an action to dispute the bill where both the bill and the customer's data are routed to the appropriate contact service to handle the dispute. In today's system actions built into the system (e.g., a “Pay Me” button) require the receiving party to manually input relevant information e.g., customer name, address, credit card number, and actions not built into the system e.g., “Dispute Bill” require the receiving party to leave the in-line process and go to an exception or out-of-line process. In an out-of-line process customer and media data must be re-gathered and verified—usually through a customer relationship management (CRM), payment, billing, and similar other systems.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system for providing support services to products according to one embodiment of the invention.

FIG. 2 is a block diagram illustrating an example of a live media services system according to one embodiment of the invention.

FIG. 3 is a processing flow of live media services according to one embodiment of the invention.

FIG. 4 is a block diagram illustrating an example of a media fabricator according to one embodiment of the invention.

FIG. 5 is a block diagram illustrating an example of a media delivery and tracking module according to one embodiment of the invention.

FIG. 6 is a block diagram illustrating a process for providing support services via an interactive media document according to one embodiment of the invention.

FIGS. 7A-7F are screenshots illustrating examples of graphical user interfaces of media service system according to certain embodiments of the invention.

FIGS. 8A and 8B are screenshots illustrating examples of graphical user interfaces for authoring an interactive media document according to one embodiment of the invention.

FIG. 9 is a flow diagram illustrating a method for providing support services via an interactive media document according to one embodiment of the invention.

FIGS. 10A-10C are flow diagrams illustrating methods for providing support services via an interactive media document according to some embodiments of the invention.

FIG. 11 is a block diagram illustrating a system for providing support services to products according to one embodiment of the invention.

FIG. 12 is a block diagram illustrating an example of a support service system of a service center according to one embodiment of the invention.

FIG. 13 is a block diagram illustrating an example of a service center according to another embodiment of the invention.

FIG. 14 is a block diagram illustrating a system for processing messages within a service center according to one embodiment of the invention.

FIG. 15 is a block diagram illustrating a service center having a social community accessing platform according to one embodiment of the invention.

FIG. 16 is a block diagram illustrating a learning system of a service center according to one embodiment of the invention.

FIG. 17 is a block diagram illustrating an example of a guided support identification system according to one embodiment of the invention.

FIG. 18 is a block diagram illustrating a support service system of a service center according to another embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a live media service is provided by a support center to process a user document of a client associated with a user as a customer of the client and to provide further support services associated with content of the user document to the user. Based on the user document, an interactive media document (which may be in a form of deployable application) is generated, where the interactive media document includes all of the necessary controls (e.g., buttons, links) that when activated, can be used to access resources (e.g., support agents, self-support knowledgebase) of the support center, right from the interactive media document. A user can initiate a communication session or interaction (e.g., voice call or chat) with the support center from an interactive media document (also referred to herein as a live media document, or simply media) without having to have a separate action to contact the support center using a separate application.

In response to a user document, the live media service embeds other relevant services—particularly those that are usually treated as an exception—into the media. In addition, the live media service is able to call an artificial intelligence (AI) engine that is able to discover media insights (e.g., media is a bill, media is a coupon, media is going to a high value customer, etc.). The live media service then writes a new piece of digital media that is “self-described” i.e., the media contains embedded meta-data that describes these insights, and builds unique service navigator menus and actions based on these insights. This new piece of media is given a unique identifier that allows it to be tracked by the live media service.

In one embodiment, the live media service attaches navigator functionality to the media that, when utilized, accesses the media's unique service navigator menus and actions. If the party who has received the media chooses a service action that is able to be processed through an automated system of the support center or a third party, the media's relevant meta-data in regard to that action and its unique identifier are pushed to the automated system and the party is able to complete their service action in that system. In cases where the service is not able to be handled by an automated system, the media's metadata, and unique identifier are pushed to a service agent. Both parties (the media's recipient and the service agent) are able to access the same piece of media, via its unique identifier, which is stored in a media journey repository. The media journey repository records any changes to the media or its metadata and keeps a tracking log that is linked to the media's unique identifier. Any changes to the media are automatically synchronized with relevant fields in adjacent systems in the enterprise e.g., CRM system, billing system, etc.

As a result, when a user or customer of a client receives an interactive media document, which have the actual user document embedded therein as well as all the controls or links, the user can initiate or perform an action that is related to the content of the user document. From the interactive media document, a user can initiate a contact with the support center for support services concerning the content of the user document, without having to make a separate action using a separate software application. For example, a user document may be an invoice or monthly statement of a product or service provided by a client as part of an interactive media document. A user can initiate a voice call or a dispute action right from the interactive media document with the support center. When a communications session is established, a support agent of the support center can quickly identify a subject matter of the communications session based on a document identifier (ID) of the interactive media document. That is, everything needed to obtain support services concerning a user document are available with the user document as part of the interactive media document. The user as a customer to a client of the support center does not have to explain to a support agent what the subject matter of the support call is, because everything associated with the user document are initiated right from the interactive media document.

According to another aspect of the invention, authoring tools are provided to a client to author a media template that can be used to fabricate an interactive media document based on a particular user document (e.g., invoice, monthly statement, health record or insurance statement). A client can design a layout or appearance of an interactive media document via the corresponding template. The authoring tools are provided via a graphical user interface (GUI) in which an administrator of a client can design an interactive media document template. In one embodiment, an authoring user interface displays a list of predefined controls, each having a specific predefined functionality. Each of the controls can be individually selected and placed (e.g., drag and drop) within an interactive media document template being designed, which will become a part of an interactive media document. For example, a control can be defined, when activated, to initiate a voice call or chat session from the corresponding interactive media document with a support agent of the support center. Another control can be defined to initiate a request for accessing a self-service knowledgebase. Subsequently, the template can be used to generate a massive number of interactive media documents based on the user documents of different users received from the client.

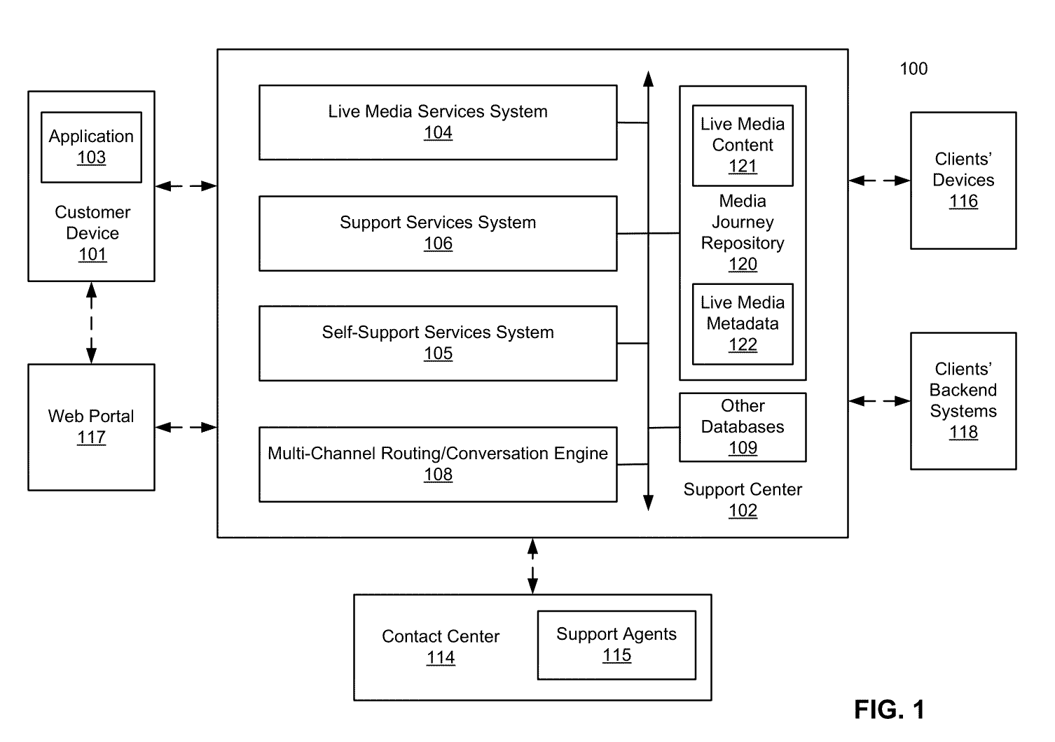

FIG. 1 is a block diagram illustrating a system for providing support services to products according to one embodiment of the invention. Referring to FIG. 1, system 100 includes a user device such as mobile device 101 of a user, running a mobile application (native, web or hybrid) of a customer, or individual communicatively coupled to support center 102 over a network. The network may be any kind of network, such as a wide area network (WAN) (e.g., the Internet), a local area network (LAN), or a combination of both. Device 101 may be any kind of devices including, but is not limited to, a laptop, mobile phone, tablet, media player, personal digital assistant or PDA, a desktop, a server, etc. Support center 102 may be implemented in a centralized facility or server with data processing hardware. Alternatively, support center 102 may be implemented in multiple facilities or servers in a distributed manner (e.g., cloud-based service platforms). Support center 102 provides services to a variety of products or services from a variety of clients or vendors. For example, support center 102 may be a call center handling a variety of support call services on products or services for a variety of goods and service providers. A client may be a manufacturer, a distributor, a retailer, a service provider or broker, a purchasing facility, or a combination thereof.

In one embodiment, support center 102 includes a support service system 106, a self-support system 107, and a multi-channel communications and routing system (MCRS) 108. Self-support system 107 is to provide a self-support knowledgebase (KB) that can be accessed by users, where the self-support KB may be generated based on internal KB (not shown) that contains certain materials that have been compiled based on previous support information and/or product information. The self-support KB may be provided by self-support system 108 in a form of Web page via a Web server (not shown), where the Web platform may be hosted by a third party and communicatively coupled to self-support system 107 of support center 102. The self-support KB is to provide a self-support platform to allow users to navigate the self-support KB information in an attempt to find a solution to its problem in question, without having to contact a support agent for live support. If after navigating the self-support KB, the customer still wants to have a live support session with a support agent, the customer can initiate a live support request to support center 102, for example, via support services system 106.

According to one embodiment, support service system 106 is to manage support service sessions between users and support agents 115. Support service system 106 may include a registration system to allow users to register products owned by the users and to allow a support agent to register and log in to provide live support services to the users. In response to a request for live support, support service system 106 generates a support case context based on the user information, client and product information, and other related information (e.g., user interactive history). Support service system 106 then routes the case context to a selected support agent to enable the support agent to have all the related information in front of him/her while conducting a live support session with a user. Further details concerning support services system 106 and self-support services system 108 are described further below.

According to one embodiment, support center 102 includes a live media services system 104 to fabricate or generate interactive media documents (also referred to as live media documents or simply live media) based on user documents received from a client, to deliver the interactive media documents to users as customers of the client, to track interactive events associated with the interactive media document, and to provide support services to the users that are initiated from the interactive media documents. In one embodiment, live media services system 104 provides an authoring platform or user interface with a set of authoring tools to allow a client to author or configure an interactive media document template. An administrator of the client can configure or place one or more controls or links at certain locations of his/her choice, which will become part of the interactive media document in combination of a user document. Each of the controls can be configured, which can be activated from the corresponding interactive media document to perform a predefined action, such as initiating a voice call, a chat session, obtaining additional information concerning the associated user document. Similarly, a link embedded in the interactive media document can be used to access a predefined resource location to obtain additional information related to the content of the associated user document.

Subsequently, when a user document is received from a client such as client device 116, the user document is converted into an interactive media document using the interactive media document template. The interactive media document would include the actual user document itself and one or more interactive controls defined by the template, as well as additional information obtained from client's backend system 118 and added to the interactive media document. The interactive media document is then delivered to the user either as a document that can be displayed by application 103 of user device 101 or a deployable application that can be deployed at a Web server 117. The interactive media document is also stored in media journey repository as part of live media content 121. In addition, events associated with the interactive media document during the process are recorded and stored in media journey repository 120 as part of live media metadata 122.

Thereafter, the user can initiate a request for support services from the interactive media document either displayed at user device 101 or Web portal 117. If the request is for a live support session with a support agent, support services system 106 is involved to identify a support agent having the best skill set for supporting the subject matter associated with the corresponding user document. A live communications session (e.g., voice, chat) is then established between the user and the selected support agent via multi-channel routing and communications engine 108. In addition, all of the data associated with the user document and the user can be identified and retrieved from databases 109 (e.g., user database, client database, product database) and/or client's backend system 118. The data associated with the user document and the same interactive media document retrieved from media journey repository 120 are then routed to a desktop of the support agent. All of the above information can be identified and collected based on a document ID that identifies the interactive media document. The interactive media document becomes a central point for obtaining support services concerning the user document embedded therein. As a result, a user does not have to separately initiate a support contact with the support center via a separate application or mechanism. A support agent providing the support services can obtain all information related to the user document when providing the live support, because everything are keyed off from the interactive media document. Note that each of the systems 104-108 can be implemented in software, hardware, or a combination thereof. They can also be hosted in different machines or servers across a network.

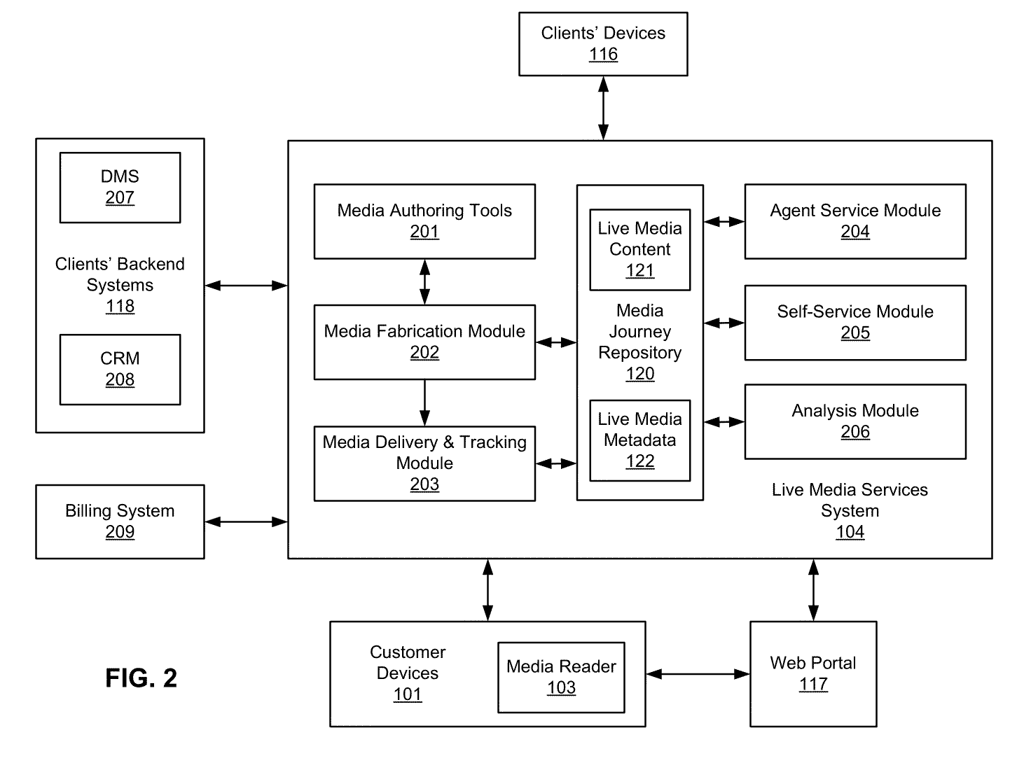

FIG. 2 is a block diagram illustrating an example of a live media services system according to one embodiment of the invention. Referring to FIG. 2, live media services system 104 includes media authoring tools 201, media fabrication module 202, media delivery & tracking module 203, agent services module 204, self-service module 205, and analysis module 206, communicatively coupled to media journey repository 120 that may be located locally or remotely over a network. These modules may be implemented in software, hardware, or a combination thereof.

In one embodiment, media authoring tools 201 provide a set of authoring tools via a graphical user interface (e.g., authoring platform which may be hosted by a Web interface or a client application) to allow a user or administrator of a client to author an interactive media document (or an interactive media document template) based on a user document intended to be delivered to an end user, such as a customer of the client. Using media authoring tools 201, an authoring user can determine or select one or more interactive controls from a list of predefined interactive controls provided by the authoring platform. The authoring user can also decide where within the eventually authored interactive media document the selected interactive controls should be located (e.g., at the left-hand, right-hand side, top, and/or bottom of the media document). Each of the interactive controls is configured, when activated from the interactive media document, to perform a predefined action, such as contacting the support center, etc. The authored templates can be stored as part of live media content 121 in media journey repository 120, which may be implemented as one or more databases.

Once the interactive media document template has been authored, it can be used, by media fabrication module 202, to fabricate or render a large amount of interactive media documents based on user documents (e.g., invoices, insurance or monthly bank statements, and health records, etc.) that are to be sent to certain users as customers of a particular client or clients. In one embodiment, in response to a particular user document received from a client (or a billing system of the client), media fabrication module 202 (also simply referred to as a fabricator) examines content of the user document and identifies a corresponding media template from media journey repository 120. Fabricator 202 converts the user document into an interactive media document using the corresponding template, where the interactive media document includes embedded therein the actual user document and one or more interactive controls defined by the media template. Fabricator 202 may generate a unique document ID that uniquely identifies the interactive media document for tracking purposes.

In addition, according to one embodiment, fabricator 202 performs an analysis on the content of the user document, and accesses other databases (e.g., client database, product database, and user database) and other information sources from the backend system(s) 118 associated with the client such as digital marketing system (DMS) 207, customer relationship management (CRM) system 208, etc., to identify additional information related to the user document. The additional information (e.g., additional notification or alert to that particular user) may be added or incorporated into the interactive media document. Some of the added information may be available to the end user, a support agent, or both dependent upon the specific configuration (e.g., a set of rules from the client that are associated with the type of the user document in question). The deliverable media document may be further converted into a deployable or publishable application that can be deployed in a publication forum, which can be accessed by the user. Fabricator 202 further records any events or activities occurred during the fabrication and stores the recorded information in media journey repository 120 as part of media metadata 122, which may be indexed by the unique document ID of the interactive media document or application.

The interactive media document is then processed by media delivery and tracking module 203. In one embodiment, media delivery module 203 examines the interactive media document to determine a delivery mechanism that is most suitable for delivering the media document in question. For example, media delivery module 203 may determine whether that particular media document should be delivered using a guaranteed delivery mechanism in which it is guaranteed that the media document is delivered to the user and a return receipt is received from the user confirming the delivery. Media delivery module 203 may further determine whether a legal signature and/or encryption are needed, based on additional information obtained from the information sources set forth above. In addition, media delivery module 203 may record, as part of metadata 122 in media journey repository 120, any activities or events during the delivery of the media document, such as, for example, when the media is sent to and/or received by the intended recipient.

Subsequently, when a request for support services is received from a user that is originated from one of the interactive controls displayed as part of the interactive media document, according to one embodiment, live media services system 104 determines whether the request is for live support services or self-support services. If the request is for live support services, agent service module 204 is involved to identify the corresponding interactive media document from media journey media repository 120 and its associated metadata. Agent service module 204 then communicates with the support services system of the support center (e.g., support services system 106) to identify and select a support agent having the most suitable skill set and to establish a live communications session between the user and the selected support agent. In addition, agent services module 204 may record any activities or events between the user and the support agent in media journey repository 120 to be associated with the corresponding interactive media document (e.g., tracked by the corresponding document ID of the interactive media document).

If the request is for self-support services, self-support service module 205 is invoked. Self-support service module 205 determines a subject matter based on the request. For example, self-support service module 205 may determine the subject matter of the request based on a document ID of the corresponding interactive media document and the interactive control of the interactive media document from which the request was initiated, where information about the document ID and the involved interactive control may be extracted from the request. Self-support service module 205 then communicates with a self-support services system of the support center such as self-support services system 105 to provide self-support services to the user. Similarly, the interactive activities between the user and the self-support services system may be recorded in media journey repository 120.

According to a further embodiment, live media services system 104 includes an analysis module 204 to perform an analysis on the data stored in media journey repository 120, such as, for example, customer's satisfaction and product/service trends, etc. The analysis results may be communicated back to the client.

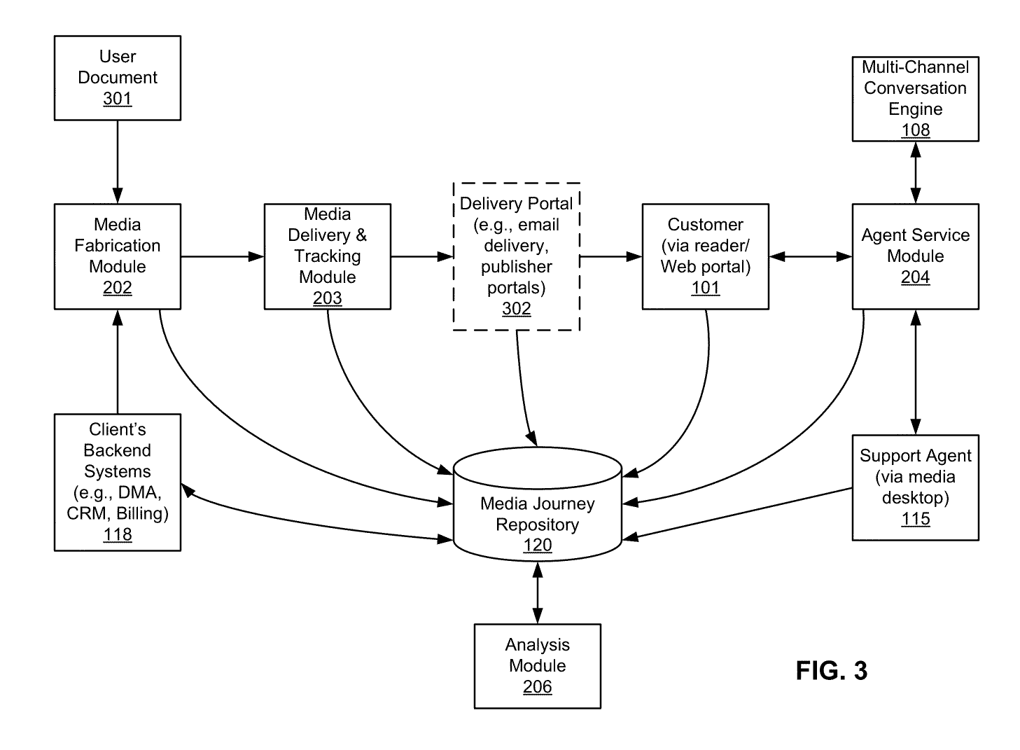

FIG. 3 is a processing flow of live media services according to one embodiment of the invention. Referring to FIG. 3, in response to user document 301 received from a client, fabricator 202 fabricates an interactive media document and/or deployable application (collectively referred to as interactive media) based on the user document and the corresponding media template, as well as the additional information obtained from client's backend systems 118. Fabricator 202 also updates the status and activities during the process in media journey repository 120. In response to the interactive media received from fabricator 202, delivery module 203 determines the best way (e.g., normal delivery or guaranteed delivery) to deliver the interactive media and optionally transmits the interactive media to a delivery portal or interface 302 to be delivered to the end user 101. Delivery module 203 and delivery portal 302 update the delivery status in media journey repository 120. Thereafter, customer 101 can initiate from the interactive media a contact with support agent 115 via agent service module 204 and multi-channel conversation engine 108, without having to separately contact the support agent via another mechanism. Similarly, the customer may also initiate a self-support service request from the interactive media to access self-support KB. Again, all of the interactions amongst all parties or modules are recorded in media journey repository 120. The recorded data collectively represents a “journey” or life cycle of the associated interactive media processed by all of the parties or components involved.

The role of the fabricator logic 202 is to transform business documents (artifacts) and business notification into an interactive media document and/or deployable application where consumers interact with. In one embodiment, the interactive media document can be in the format of a portable document format (PDF) and a WORD document (e.g., extensible markup language or XML-based WORD document). Fabricator 202 also packages the media document also as Web application modules such that the subsequent web application publisher can deploy them to customer web portals. Fabricator 202 updates the media journey repository 120 about creation events of the media documents, web application publications along with metadata, as well as the metadata surrounding likely abnormal content—for example to support first bill shock. Inputs to the fabricator 202 can be any data sources such as, but not limited to, digital marketing sources, billing sources, customer relationship management sources, business process management sources. Outputs of the fabricator 202 are the live media documents and notifications to media delivery agents such as e-mail, short message services (SMS), social media posts, and datasets to web-app packaging agents or video-app packaging agents.

Once the live media is created, the delivery & tracking module 203 is responsible to put this fabricated media to customer's hand. According to one embodiment, at least three categories of media delivery can be utilized: 1) embedded media delivery to the customer, where the entire fabricated media are attached to the delivery vehicle; for example, as part of an email to the customer email address; 2) linked media delivery using universal resource identifier (URI) pointer to the location where the fabricated media can be retrieved: for example a link from a social media post; and 3) web application shell wrapping the fabricated media, allowing posting of fabricated media based “web parts” into enterprise portals.

Functionality of the delivery & tracking module 203 may include 1) guaranteed media delivery includes the creation of metadata such as proof of legal delivery, content and time of arrival, recipient action with the media delivered; 2) tracking of return message, on-demand reconstruction of original message content including attachments, transaction meta-data, delivery status; 3) content encryption, encrypted transmission, electronic signatures, sender authentication. All media delivery and return events, as well as metadata (such as described above) are updated to media journey repository 120. Outputs of the deliver & tracking services may include 1) delivery interfaces to message infrastructure companies managing global email, routing and message delivery between people, systems and applications location on-premises, in-cloud or on mobile devices and 2) deployment interfaces to enterprise portals that allows customers to interact with business documents and notifications through web browsers.

The customer receives and view and work with the live media through user interactive platform, referred to herein a media reader application, working in conjunction by a cloud-based orchestration system. The reader's roles may be configured to 1) present the media documents to the customers; 2) relate the context of likely next possible responses and gather the appropriate support information (metadata) from the media journey repository on the customer's behalf; 3) upon receiving a customer response, shepherd the response through the appropriate enterprise policies, routing and processing automation to simplify and optimize the customer effort; and track the response workflow, results until the customer requested actions are completed and closed.

The media reader enables a customer to act and manage their personalized responses to digital business-to-business (B2B) or business-to-consumer (B2C) documents such as, for example, 1) digital invoices, receipts where a customer can inquire, pay, and dispute, 2) digital warranties where a customer can inquired, claim, and get replacement, 3) digital financial statements (for example: bank statement, insurance statement) where the customer can view and dispute, 4) digital government documents (for example: birth certificates, passports) where a customer can apply and renew, and 5) digital notifications for e-commerce, m-commerce events, alerts where the customer can act on. The outputs of the media readers are orchestrated through to responsible enterprise services systems such as DMS systems, CRM systems, business process management (BPM) systems, contact centers, and enterprise self-service resources.

As the customer response requires customer services handling, across any communication channel of preference to the customer, to a contact center, the agent service module 204 comes into focus. Agent service module 204 is to ensure customer response is routed to the best service end point based upon complexity of the customer request, the state of mind of the customer, ensure the appropriate channel usage, and simplify service agent task by supporting unified service desktop scheme. The agent service module 204 may be coupled or integrated via data/event exchange hubs with some customer services support systems, CRM systems (e.g., salesforce.com), contact center communications systems, virtual agent systems, etc.

As the customer response requires customer services handling, across any communication channel of preference to the customer, to a contact center, the agent service module 204 comes into focus. The agent service module 204 ensures customer response is routed to the best service end point based upon complexity of the customer request, the state of mind of the customer. Customer responses are divided into at least two categories: those that are purely transactional and those that require a dialog. To support transactional communication, The agent service module 204 uses the media data, the metadata in the media journey repository 120 to create an on-demand organic interface between back end systems (that if façade such as DMS, CRM, BPM, Billing etc.) and the customers. Such communication may be delivered through existing customer service self-service equipment such as touch tone interactive voice recording (IVR), speech recognition, web based self-service with the speed and flexibility of visual information. To support interaction communication, the communication can be routed to the appropriate contact center skills based on the complexity of information requested or to an appropriate customer personal advocates based upon measured customer psychological circumstances

In addition, agent service module 204 ensures the appropriate channel usage, where the decision is based upon historical knowledge of effectiveness of channel, speed of conclusion, channel availability, painlessness, ease of use of the customer, and low cost of use. The agent service module 204 simplifies service agent task by supporting unified service desktop scheme via abstract multichannel data, working with the media data, the metadata collected about the media from the media journey repository, metadata collected from back-end systems, working and exchange data with virtual assistant engines, answer engines, case-based reasoning and logical dialogue path engines.

The analysis service 206 performs an analysis on the data stored in media journey repository 120. It aligns the customer experience (CX) values defined by industry best practices as methods to identify and measure the value of the live media services. Customer Experience aspects of the entire cycle (business event causing document creation—to customer consumption/reaction—closure) can be analyzed for acquisition, retention, and efficiency. Each area has strategic and operational measurements that the media service system collects raw data, continuously measure and monitor KPIs. Acquisition refers to the ability to increase the enterprise's customer base. Retention refers to the ability to keep and grow the customers that the enterprise already has. Efficiency allows the enterprise to do more with less effort/resources. The analysis service provides datasets in various areas, such as, for example, generation of further opportunities, insights to increase brand equity, insights of market share gains, insights into share of wallet gains, loyalty drivers, advocacy drivers, return on invested capital (ROIC), EVA, productivity drivers, and insights to decrease cost of operations. The outputs of the analysis service are datasets that serve as inputs to predictive analytics models, statistical models, as signals to data-driven decision support systems, and as signals to complex, multi-faceted data-driven process orchestration systems.

The Analysis service performed by analysis module 206 provides datasets in at least following areas: generation of further opportunities, insights to increase brand equity, insights of market share gains, insights into share of wallet gains, loyalty drivers, advocacy drivers, ROIC, EVA, productivity drivers, insights to decrease cost of operations, and strategic KPI information. the strategic KPI includes: direct traffic/indirect traffic/unidentified traffic sources, brand mentions, conversion rates, rate of adoption, average order value (AOV), marketing campaign effectiveness, views per media, up, cross-sell abandonment, frequency of media view, churn rate, net promoter score (NPS), customer satisfaction (CSAT), customer effort score (CES), emotion score, average resolution time, delivered services uptime, channel accessibility, channel costs, cost of services, cost of sales, marketing costs, cost per interaction/activity, self-service rate, cost of acquisition, cost of retention per customer, first contact resolution (FCR), average handle time, initial training time, content effectiveness, and escalation percentage to assisted channels.

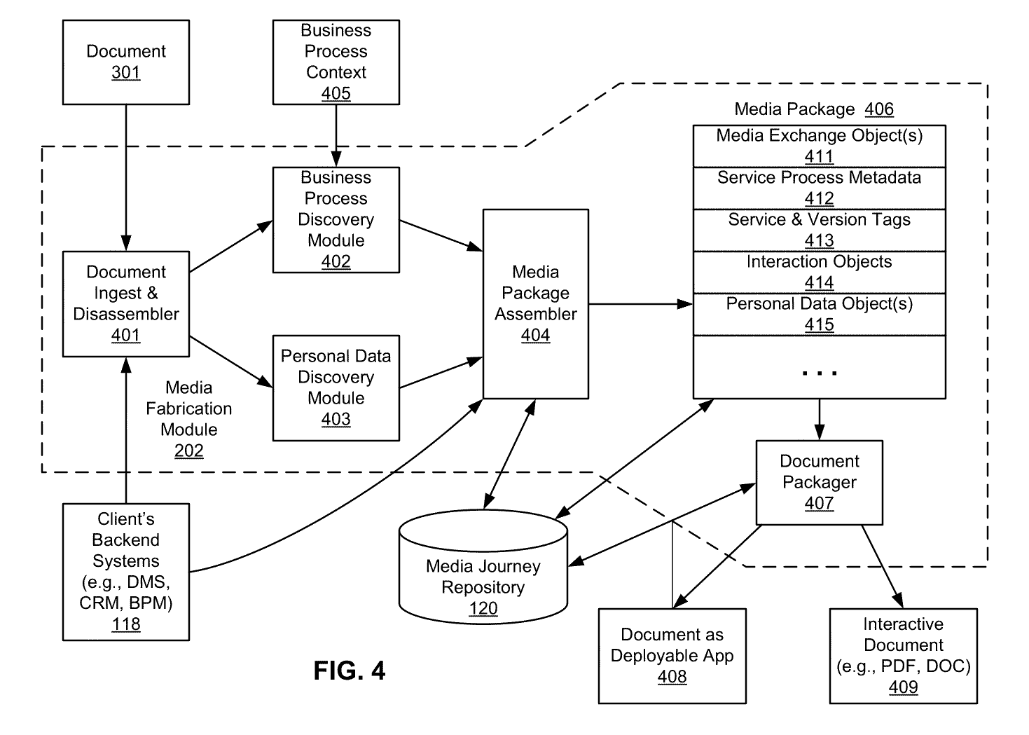

FIG. 4 is a block diagram illustrating a media fabrication module of the live media services system according to one embodiment of the invention. Referring to FIG. 4, fabricator 202 produces a self-describing document with routing information such as who receives the media and media channel delivery option. The media's originating information is generated by a pointer to a Web link (URI), database, image, metadata, etc., with media and recipient information and secure process tags. Fabricator 202 uses the media as the control for the customer interaction in contrast to controlling enterprise customer transactions with customer relationship management (CRM) and computer telephony integration (CTI) system identifiers from associated data dips, incident and ticket numbers, traditional enterprise customer databases and data warehousing systems. Here, the media is the focal point, with connections to all other digitally connected elements of the transaction.

In one embodiment, media fabricator 202, which may be implemented as logic containing software, hardware, or a combination thereof, includes a document ingest and disassembler 401 to receive user document 301 from a client, disassemble the user document into various pieces of information, and ingest in additional information client's backend system 118 (e.g., via communications hubs or interfaces to DMS, CRM, BPM, and/or billing systems). Document ingest and disassemble 401 is to discover the context of user document 301 and turn into possible actionable event, for example, using natural language query (NLQ) and semantic inference technology. For example, based on the information extracted from the user document, document ingest and disassemble 401 determines the type of the user document 301, client information, and user information. For example, if user document 301 is a welcome letter, disassembler 401 may determine demographics of the user associated with the user document (e.g., recipient), business or client rules related to the user. If user document 301 is an invoice or monthly statement, disassembler 401 may determine whether the payment is late.

In one embodiment, fabricator 202 further includes a business process discovery module 402 and a personal data discovery module 403. Business process discovery module 402 is to access business process context 405 (which may be obtained from the BPM system) associated with user document 301 to obtain the related business process data. Examples of the business process data include explanation of the subject matter, billing date, due date, etc. of the user document 301. Personal data discovery module 403 is to extract personal information of the recipient from user document 301, such as the contact information (e.g., name, address, email, phone, account number) of the recipient. All of the above information provided or generated by document disassembler 401, business process discovery module 402, and personal data discovery module 403 are used by media package assembler 404 to generate a media package 406 that is specifically associated with user document 301 and the eventually generated interactive media documents 408-409. Media package 406 serves as an information or metadata container (e.g., XML container) containing all the related information, which may be stored in media journey repository 120 and tracked by a document ID that uniquely identifies user document 301 and/or media documents 408-409.

Media package 406 includes various objects for storing a variety of data associated with the user document 301 and media documents 408-409. In one embodiment, media package 406 includes a media exchange object 411, service process metadata 412, service and version tags 413, interaction objects 414, and personal data object 415. Media exchange object 411 stores any data exchanged between the user and the support center, such as, for example, communications channel used, email, link, Web sites accessed, etc. Service process metadata 412 store information of business process steps. Service and version tags 413 stores any time and version stamps whenever an event or modification occurs with respect to the interactive media document by the user and/or a support agent. Interaction object 414 stores information represent any interaction of the user with respect to the interactive media document. Personal data object 415 stores personal data of the user. Thereafter, document packager 407 packages user document 301, media package 406, and the template described above to generate an interactive media document, either in a deployable application 408 or certain types of documents 409 (e.g., PDF, WORD documents).

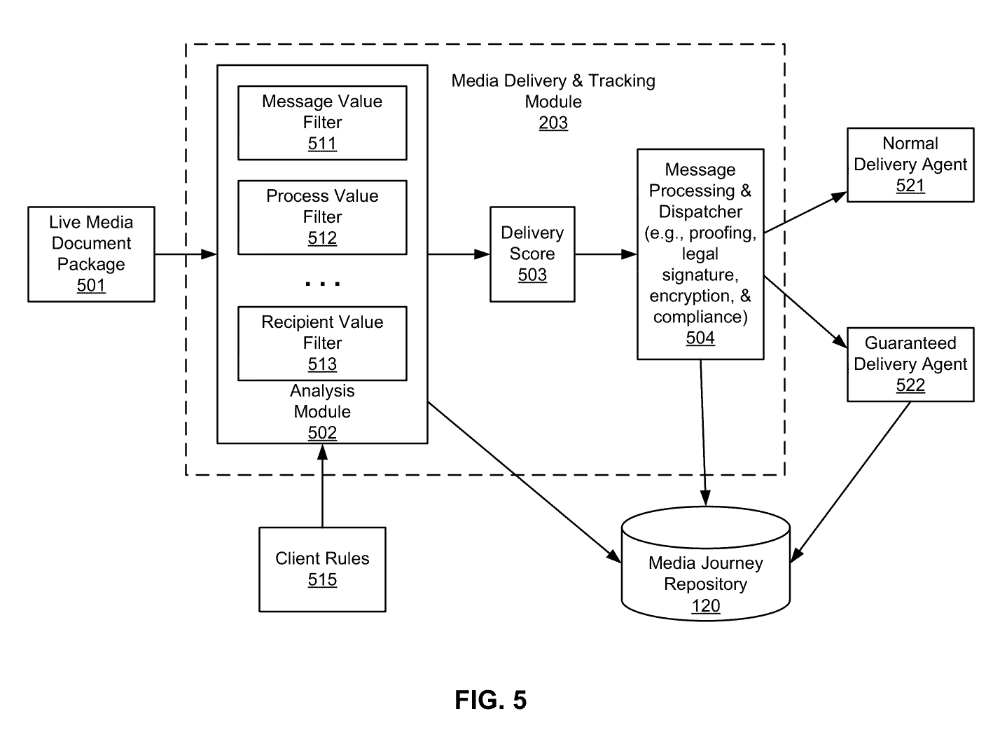

FIG. 5 is a block diagram illustrating an example of a media delivery and tracking module according to one embodiment of the invention. Referring to FIG. 5, media delivery module 203 includes an analysis module 502 to perform an analysis on media document package 501 produced by the media fabricator to determine the most appropriate way to deliver the media document to an intended recipient. In one embodiment, analysis module 502 perform the analysis based on a set of rules associated with the client to determine a delivery score 503 representing the priority or importance of the media document to be delivered (e.g., higher the delivery score, higher the priority/importance will be).

In one embodiment, analysis module 502 employs a set of filters or templates to perform pattern matching analysis to determine the characteristics of the media document package 501. Note that the media document package 501 may include the actual user document such as document 301 and the media package 406 generated by fabricator 202. In one embodiment, the set of filters includes message value filter 511, process value filter 512, and recipient value filter 513. These filters may be configured by the client via a user interface (not shown). Message value filter 511 is used to match certain keywords occurred in content of the corresponding user document, which may be determine the type of the user document. Process value filter 512 is used to determine the business processing stage associated with the user document (e.g., whether this is the final notice or warning message). Recipient value filter 513 is used to determine the importance of the intended recipient. Based on all of information obtained via filters 511-513, analysis module 502 computes delivery score 503.

Based on delivery score 503, according to one embodiment, message processing and dispatch logic 504 determines whether the media document should be delivered via regular delivery agent 521 (e.g., normal email delivery hub) or guaranteed delivery agent 522 in which the media document is guaranteed to reach the intended recipient and a return receipt will be received from the recipient and stored in media journey repository 120. Based on the analysis result generated by analysis module 502, message processing logic 504 may perform additional actions with respect to the media document. For example, logic 504 may add legal signature, encrypt at least the content of the document, and enable the document to be compliant to the necessary regulation. In another example, if the document is a final notice of a utility service, a cable/Internet subscription, or medical/life insurance that is about to expire or to be shut down without payment, the document may be delivered via a guaranteed delivery mechanism to make sure the recipient receives the final notice. Again, all of the processes or events are tracked and stored in media journey repository 120.

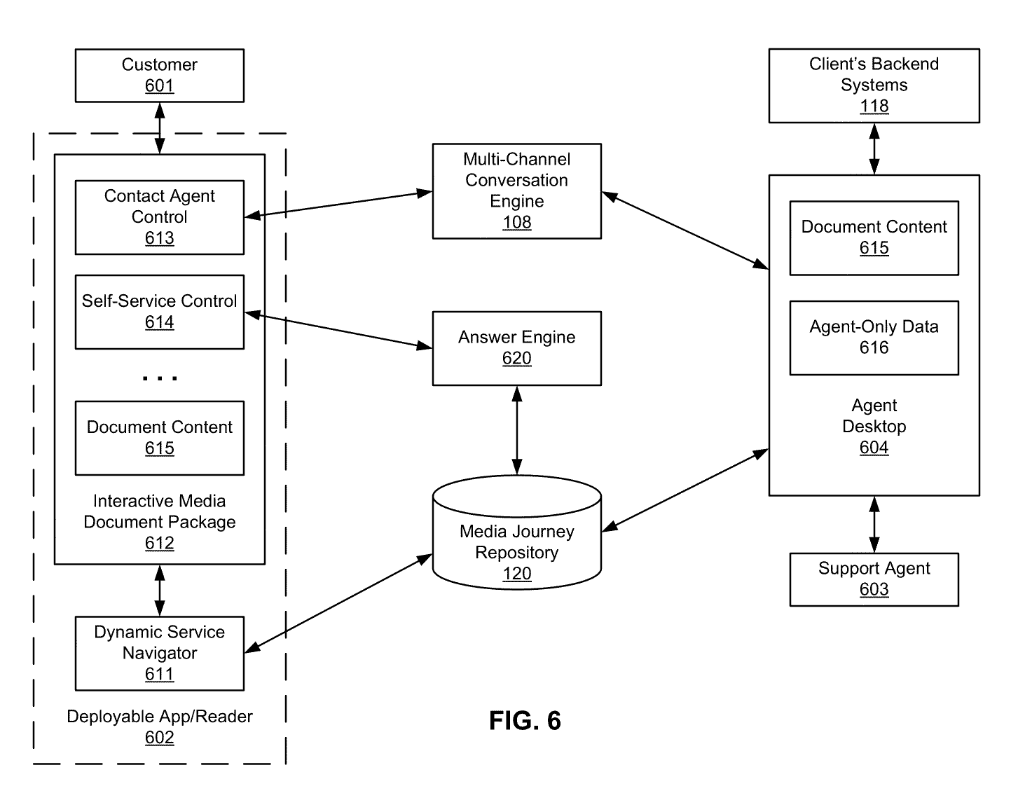

FIG. 6 is a block diagram illustrating interaction between a user and support center via interactive media document according to one embodiment of the invention. Referring to FIG. 6, when customer 601 of a client receives interactive media document 612, it may be displayed by a media reader or presented as a deployable application 602. As described above, interactive media document 612 includes one or more interactive controls embedded by the media fabricator during the media fabrication, including but not limited to, contact agent control 613 and self-service control 614, etc., as well as the user document content 615. In addition, dynamic service navigator 611 is communicatively coupled to interactive media document 612 to monitor and capture any user interaction with controls 613-614. Dynamic service navigator 611 may be implemented as part of the media reader application or alternatively, as part of the deployable application.

In one embodiment, contact agent control 613 is associated with executable code, which when executed, will initiate a contact with the support center in an attempt to reach a support agent for a live support session. For example, when user 601 reviews document content 615 (e.g., user document intended sent by the client) and has some questions concerning the document content 615 and would like to have a live conversation with a support agent, user 601 can activate or click on control 613 right from the displayed interactive media document, without having to leave the currently displayed interactive media document and separately initiate a call to the support center.

In a conventional system, a typical user would have to look up a phone number listed in the document and use a physical phone or similar device, or a separate voice over IP (VoIP) dialing application to initiate a voice call. Similarly, if the same use wish to have a chat with a support agent of the support center, the user has to figure out the chat destination address or ID of a support agent or obtain the same from client's Web site listed in the document. The user then would have to launch and use the separate chat application outside of the currently displayed document to initiate a chat session. When the session has been established, the user has to explain to the support agent which of the documents or subject matters/questions he/she refers to for the corresponding support session and the support agent has to spend time to find the same record based on the information provided by the user over the phone or chat session. Sometimes such information is inaccurate or incorrect, which leads to more frustration between the user and the support agent and poor customer satisfaction.

In one embodiment, support services associated with a particular user document, as well as, all the necessary related information, can be initiated or obtained right from the interactive media document presented to the user. Everything associated with the document are tracked or indexed based on a unique document ID that uniquely identifies the interactive media document, such that a support agent can quickly retrieve all the associated information based on the document ID. Since all the associated information are tracked by the document ID, the support agent does not have to manually identify and screen out any unrelated information. As a result, the support services can be conducted in a more efficient way, which may leads to better customer satisfaction and lower overall support cost.

Referring back to FIG. 6, when user 601 decides to contact a support agent of the support center, user 601 can simply click at contact agent control 613 displayed within interactive media document 612. In response, dynamic service navigator 611 captures such an event and transmits a request to the support center for a live support session. In one embodiment, the request includes a document ID that uniquely identifies the interactive media document 612. The request is received by the agent service module 204 of media services system 104 at the support center of FIG. 2. Referring to FIGS. 1-2 and 6, agent service module 204 accesses media journey repository 120 to identify the corresponding interactive media document and its associated metadata stored therein based on the unique document ID extracted from the request. Agent service module 204 invokes support services system 106 of FIG. 1 to determine and select a support agent based on the information (e.g., interactive media document and its metadata) provided by the agent service module 204. Support services system 106 may determine a set of skills that required handling the support of the content of the interactive media document and select a support agent having the required skill set.

Support services system 106 causes a live communications session between user 601 and selected support agent 603 to be established, for example, via multi-channel conversation engine 108, which may be maintained by the support center or a third party entity dependent upon the specific configuration or rules of the client. In addition, the same interactive media document and/or the actual associated user document (either the physical copy of the content or a link to a storage location, such as a Web page, storing the information) may be routed to an agent desktop 604 of support agent 603 to be displayed as part of document content 615. Additional information associated the interactive media document can also be determined and displayed as part of agent-only data 616, such that both user 601 and support agent 603 are literately on the “same page” during the live communications session.

Similarly, if user 601 decides to contact a self-support system without talking to a support agent, user 601 can click on self-service control 614 to initiate a dialog interface within the interactive media document to ask a question concerning the document content 615. In response to the interaction with control 614, dynamic navigator 611 captures the interactive event, as well as the question being asked, and transmits the request to the support center, where the request is received by self-service module 205 of media services system 104. The self-service module 205 then extracts a document ID that uniquely identifies the interactive media document from the request and determines a subject matter of the query based on the document ID. The self-service module 205 then communicates with self-support service system 105 of the support center, which may invoke an answer engine 620 to provide a predefined answer to the query. The answer is then transmitted back to the user and displayed in the dialog interface within the interactive media document. All of these events or operations occur without requiring the user to leave the interactive media document.

Note that when media document 612 is presented at a user device, it may be presented by a media reader application installed at the user device. The media reader includes the functionality of dynamic service navigator 611 embedded therein to render, interpret, and display the content of the media document, to monitor and capture any user interaction with the displayed content, to analyze and understand the user intent, and in response to a user interactive event, to perform an action that is most appropriate at the point in time, including contacting the support center, etc. The media reader renders and understands the meaning contained within the media document. It knows who the user is and understands how to relate the user and the context of the media document, as well as the user's preference towards how to take an action with the media document. The media reader relates the context of likely “next responses” and gathers the appropriate support information on the user's behalf. The media reader renders the potential next responses, along with supporting information into the graphical user interface so that the user can easily invoke the tools provided at the user interface. In response to a user action, the media reader routes all of the information it gathers to the support center for further actions and tracks the workflow and results until the user request has been completed and closed. Similarly, when the media document 612 is deployed as an executable application such as a Web deployable application, the functionalities of a media reader (e.g., dynamic service navigator 611) described above will be incorporated within the deployable application.

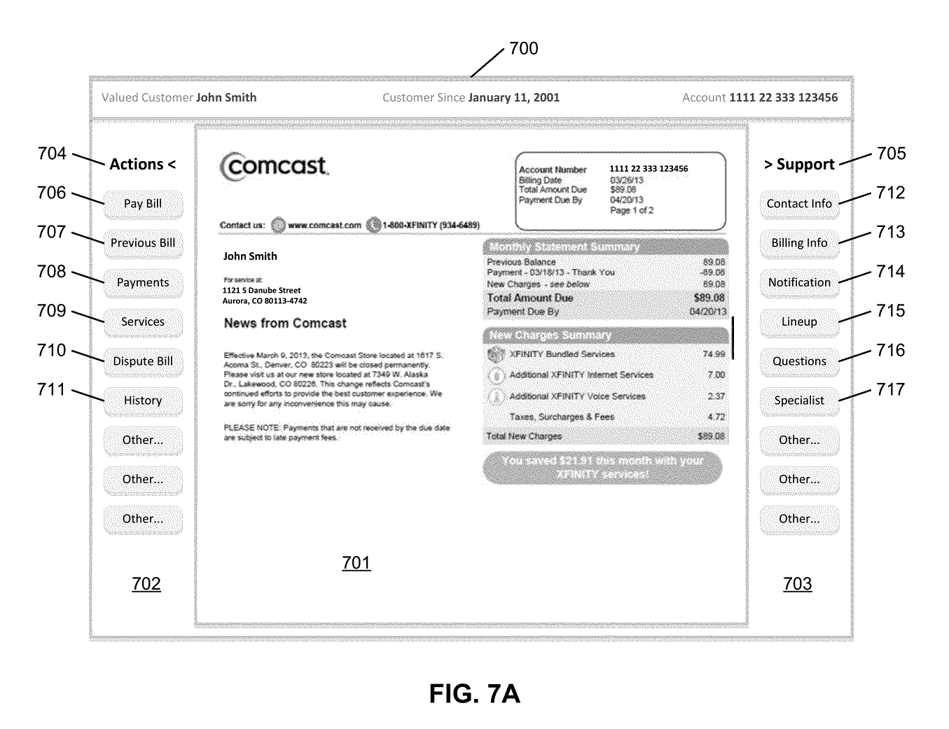

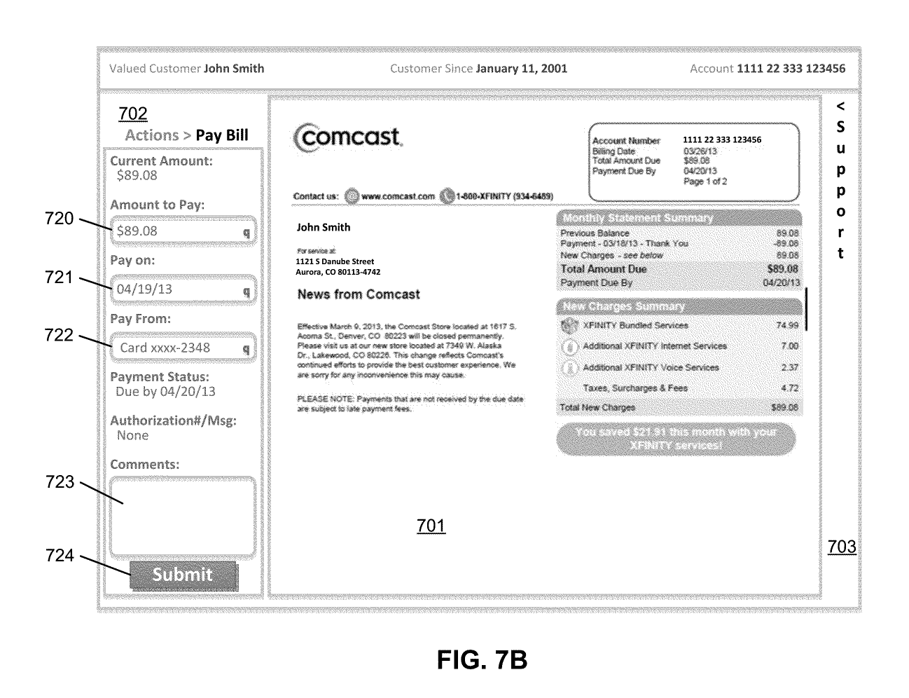

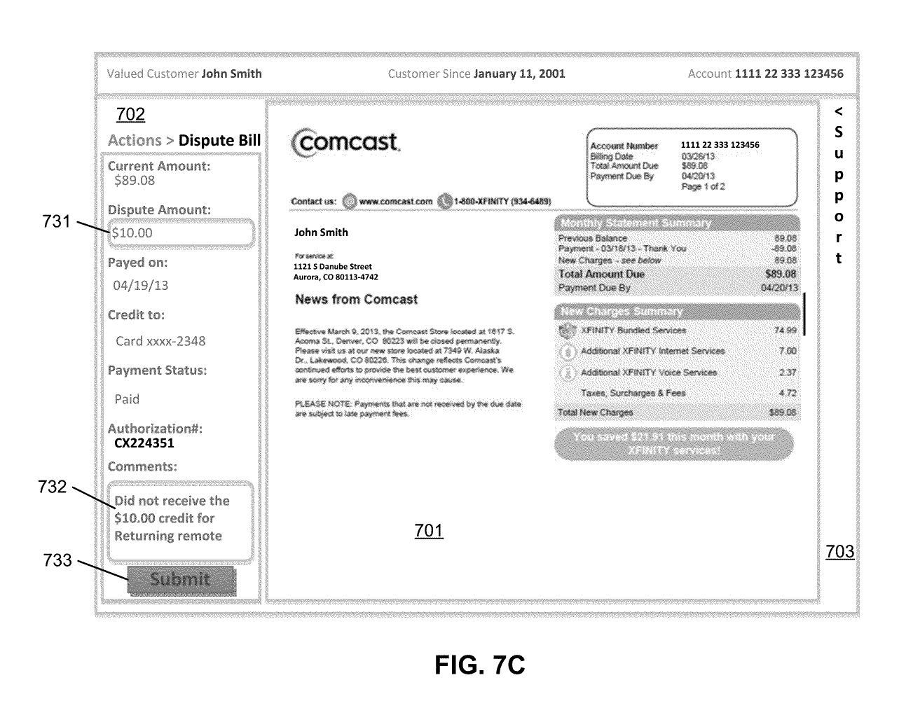

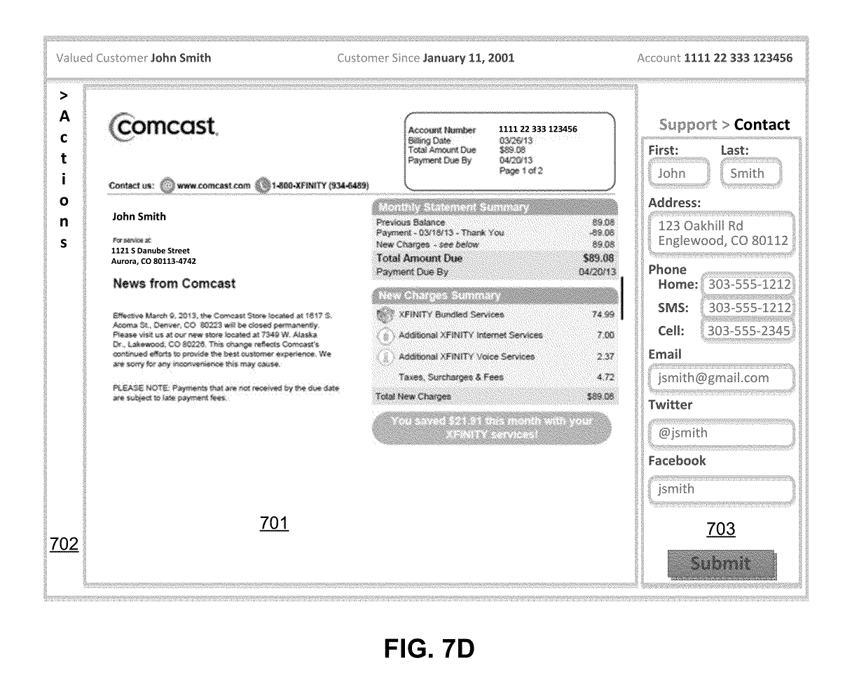

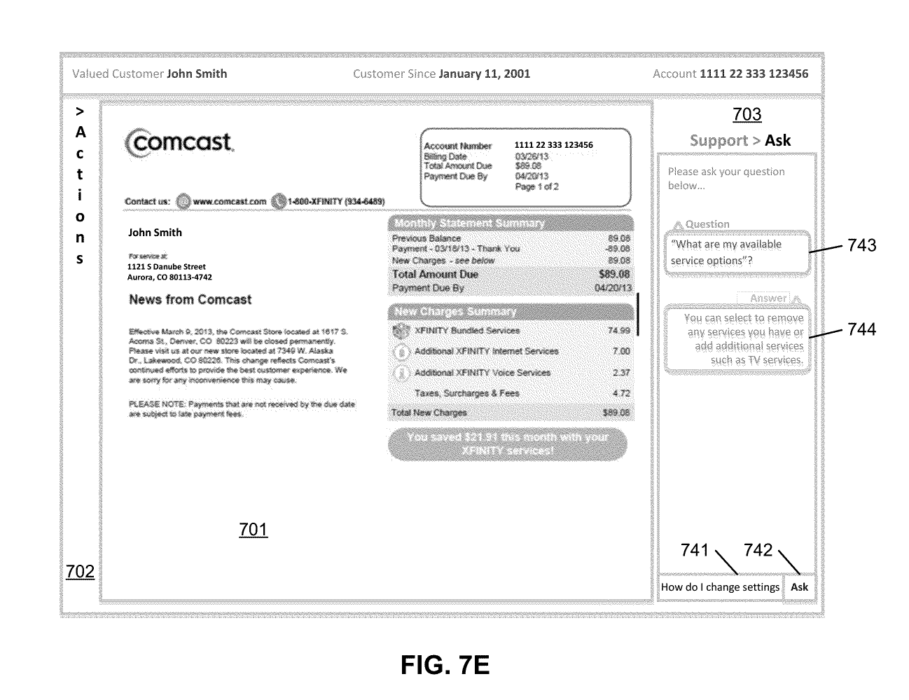

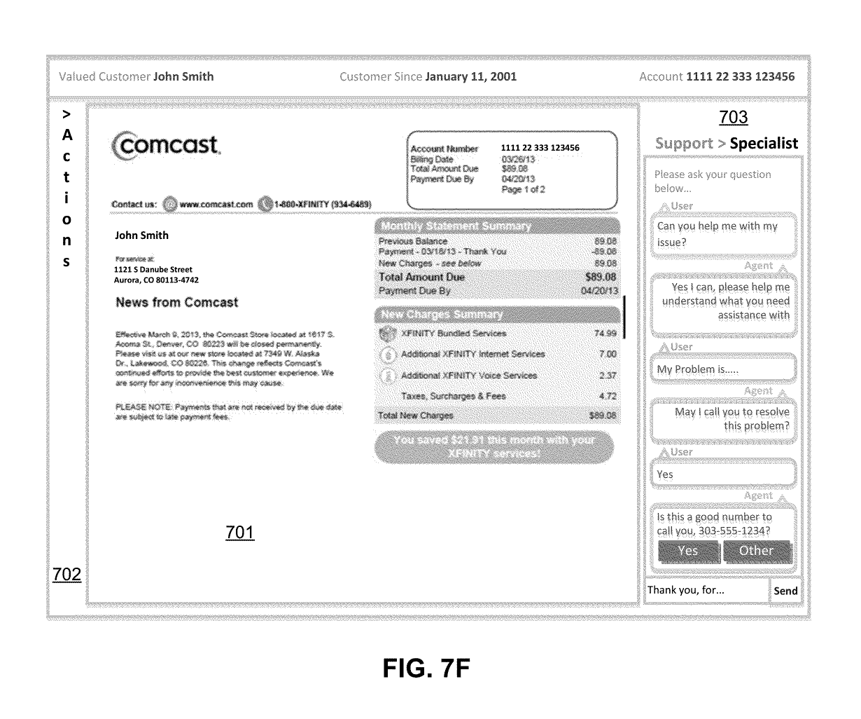

FIGS. 7A to 7F are screenshots illustrating examples of graphical user interfaces of an interactive media document according to certain embodiments of the invention. The interactive media document as shown in FIGS. 7A-7F may be presented by a media reader or as an deployable/executable application. Referring to FIG. 7A, GUI 700 includes at least a first display area 701 to display a user document that a client intended to send it to its customer, a second display area 702 to display one or more controls that a customer can perform an action or actions with respect to the user document displayed in display area 701, and a third display area 703 to display one or more controls that the customer can obtain support services from the support center regarding the user document.

The authoring tool is a component of the live document solution framework that allows a company to create a specific document which will be sent to their customers electronically as an interface to their account. Customer specific information can be included and submitted to one or a number of customers (each with their own specific info) for specific purposes, such as, for example, billing for a service or product, notification of payments, ordering a product or service, dealing with healthcare billing and insurance filings, filling out forms and surveys, responding to flyers and sales memos, interacting with a care provider or pharmacy, etc. The solution has the following capabilities available to author an interactive media document, authentication of a user by utilizing their account credentials, inclusion of the document sent to a user such as; invoice, bill, notification, survey/questionnaire, request for account information, and inclusion of client data necessary to populate specifics in the interactive media document for a user's interaction.

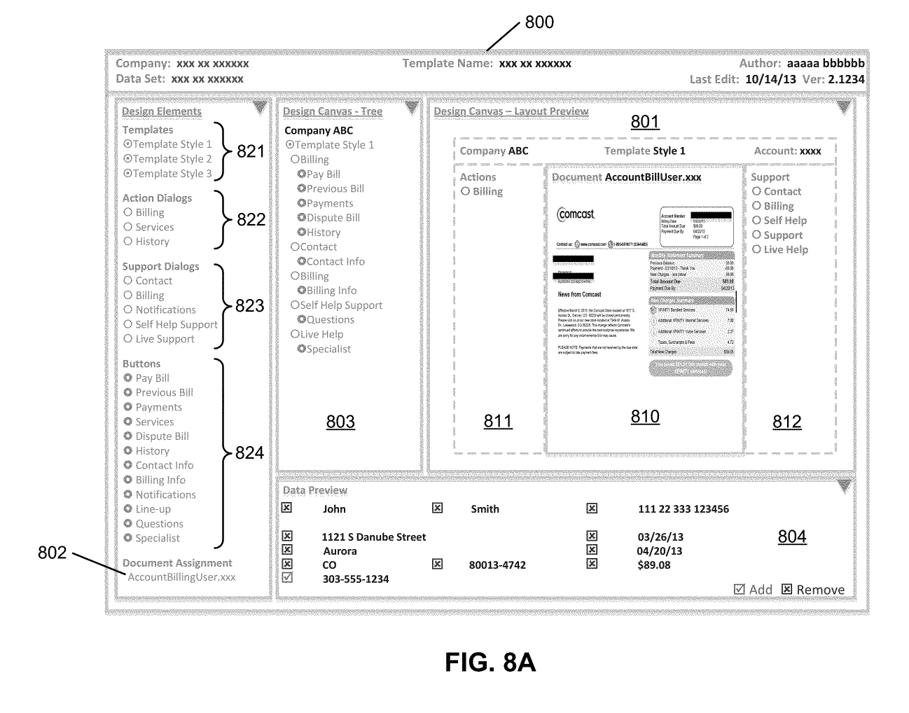

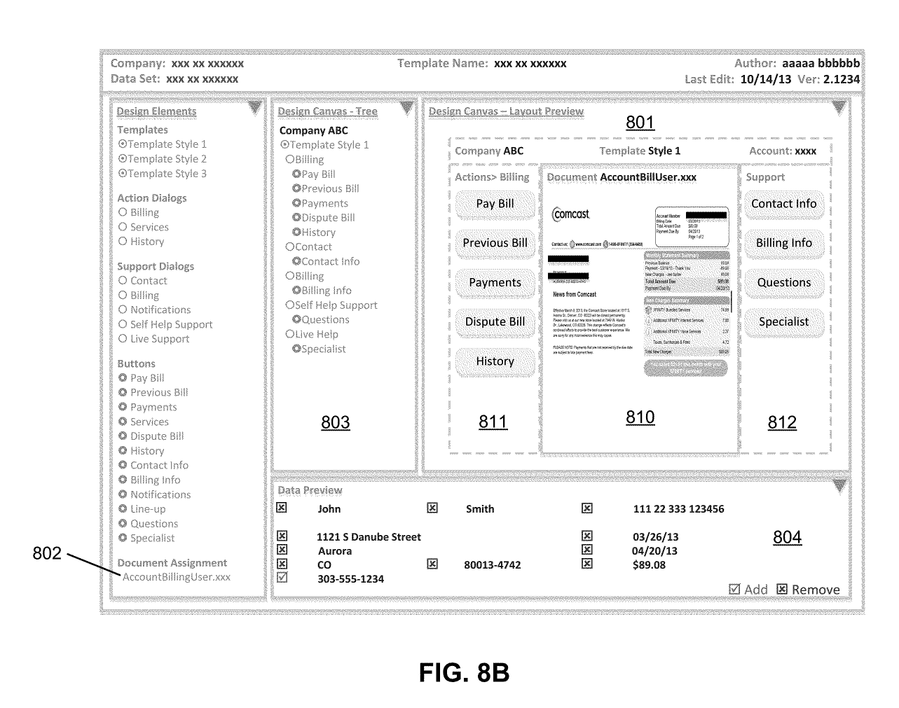

Referring back to FIG. 7A, action panel 702 can be expanded and collapsed via control 704. Similarly, support panel 703 can be expanded and collapsed via control 705. Within action panel 702, interactive controls 706-711 are displayed and can be used by a customer. Controls 706-711 may be configured by an administrator of the client via an authoring user interface such as those shown in FIGS. 8A and 8B, and rendered by media fabricator 202. For example, as shown in FIG. 7A, control 706, when activated, will allow a user to initiate an action to pay the bill associated with the user document 701, which in this example, a bill or invoice from Comcast®, a client of the support center. Similarly, the user can obtain previous bills via control 707, review prior payments via control 708, modify services (e.g., subscribed services) provided by the client via control 709, dispute the bill currently displayed in display area 701 via control 710, and view the user account history via control 711.

According to one embodiment, a user can also obtain support services from the support center via controls 712-717. For example, as shown in FIG. 7A, a user is able to modify the contact information of the user account associated with the user document 701 via control 712, to process billing information changes via control 713, to view account notification settings via control 714, to view the additional service information (in this example, the TV lineups) provided by the client via control 715, to ask a self-service question via control 716, and to contact a support agent for live support via control 717. All of the controls displayed in panels 702-703 are fabricated by the media fabricator 202 in response to a particular user document 701. A user can obtain all the related information and support services concerning the user document displayed in panel 701 right within the media document 700, without having to leave and launch another application.

Referring now to FIG. 7B, according to one embodiment, the GUI page as shown in FIG. 7B is displayed in response to an activation of control 706 from FIG. 7A. In this example, the detailed information and layout associated with pay bill control 706 is displayed within action panel 702 by hiding the rest of the controls. In this example, the support panel 703 has been collapsed, for example, via control 705 of FIG. 7A. In this example, the user can enter an amount of payment he/she wants to pay in field 720, the date the payment should be paid in field 721, payment source (e.g., credit card, Paypal™) in field 722, and comments or messages in field 723. Once the user clicks on submit button 724, all of the information entered in panel 702 are transmitted to either the support center or the billing system designated by the client. The underlying dynamic navigator will take care of everything else, including authentication process of the user with respect to the support center and/or the client designated system (e.g., billing system). As a result, the user does not have to go to the separate Web site to pay the bill.

Referring now to FIG. 7C, according to one embodiment, the GUI page as shown in FIG. 7C is displayed in response to an activation of dispute control 710 from FIG. 7A. In this example, in response to an activation of button or control 710, the processing logic displays the detailed information concerning the payment being disputed, including the current amount that has been paid, the date the payment was made, payment instrument, and the authorization. The user can enter amount in dispute in field 731 and he/she can also enter some comments in field 732. Once the user enters all the necessary information from the action panel 702 and clicks the submit button 733, all the information are captured and transmitted to an appropriate entity that handles the payment dispute. As a result, all of the above operations can be initiated right from the interactive media document and the user does not have to contact the client separately.

Referring now to FIG. 7D, according to one embodiment, the GUI page as shown in FIG. 7D is displayed in response to an activation of button or control 712 of FIG. 7A. In this example, a user can register or modify his/her contact information of a user account associated with the user document displayed in panel 701 or a user account of the user registered in the support center, such as, for example, name, address, phone number, email, and other social network communities identifiers. The user can also register or enter the necessary credentials (e.g., user identifiers, passwords) required to log into those account displayed in panel 703, where the credentials will be cached and stored in the support center to be used subsequently by the user for login purposes without having to provide the same again. The user can just simply logs into his/her account in the support center and from there, the user can access all his/her other accounts via the associated APIs from the support center using the credentials cached in the support center. Once the user clicks on the submit button, all of the information provided in panel 703 will be transmitted to the support center and stored in a user account or database associated with the user.

Referring now to FIG. 7E, the GUI page is displayed in responses to an activation of control 716 of FIG. 7A. Through this GUI page, a user can access a self-service system (e.g., self-service module 205 and self-support service system 105) of the support center to ask a question, which may be answered by an answer engine (e.g., answer engine 620) of the support center to provide one or more predefined answers in response to a question. In this example, a user can enter a question in field 741 within the displayed interactive media document and submit via submit button 742. In response to the submission, processing logic (e.g., underlying dynamic navigator) captures the event and gathers all the associated information (e.g., posted question, document ID, etc.) and transmits the information to the support center over a network. The question may also be posted within panel 703 such as question 743.

When the support center receives the request, it can identify the subject matter of the question being asked. For example, based on the document ID of the interactive media document the self-support service system can determine the subject matter of the query in view of the question being asked. In this example, the question being asked has something to do with the content of the user document, the user associated with the user document, the product or client associated with the user document, etc. As a result, a more accurate answer can be identified and retrieved from the knowledgebase. When the answer is received by the interactive media document, it can be displayed within panel 703 such as answer 744. All of these actions are initiated within the interactive media document. The user does not have to access the knowledgebase separately, which may require the user to browse different sections of the knowledgebase or submit many questions in order to find the relevant information that is related to the content of the user document in question.

Referring now to FIG. 7F, which may be displayed in response to an activation of control 717 of FIG. 7A. In this GUI page, a user can initiate a request to contact a support agent for a live support session such as a voice, video, and/or chat session. As described above, when button 717, a request for live support is transmitted to the support center over a network, where the request includes a document ID that uniquely identifies the interactive media document displayed in panel 701. In response to the request, agent service module 204 and support services system 106 identify and determine all of the relevant information associated with the user document based on the document ID, including determining a skill set required to provide live support and identifying a support agent having the required skill set. Then a live communications session, in this example a chat session is established between the user and the selected support agent. The exchanged communications, in this example, the exchanged texts are displayed in panel 703, as well as tracked in the media journey repository 120. Note that the GUI layout or configuration as shown in FIGS. 7A-7F is shown for illustration purpose only; other configurations may also be applied.

FIGS. 8A and 8B are screenshots representing examples of a graphical user interface for authoring an interactive media document according to one embodiment of the invention. GUIs as shown in FIGS. 8A and 8B may be implemented as part of media authoring tools 201 of FIG. 2. The GUIs as shown in FIGS. 8A and 8B may be hosted in a cloud server as a software as service (SaS) platform or a local application installed at a local machine (optionally communicatively coupled to a server). A media document designer can design an interactive media document template that can be used, for example, by media fabricator 202, to generate a large amount of interactive media documents based on the corresponding user documents. For example, a designer associated with a client can design an invoice template to generate interactive invoices from regular invoices from a billing system of the client. The designer can design a layout of the interactive invoice by adding all the necessary relevant information and controls, such as, for example, control to pay bill, control to dispute an invoice, control to ask a question from a self-support service system, and/or control to contact a support agent of the support center for a live support session, etc.

Referring to FIG. 8A, GUI 800 includes a first display area 801 as part of design canvas to design and preview an interactive media document template. In this example, canvas 801 includes area 810 to display a sample user document (e.g., invoice) that can be substituted by subsequent invoices of a mass production when the template is used. In this example, a designer decides to add an action panel 811 and support panel 812 to the template. GUI 800 further includes a second display area 801 to provide a list of previously configured controls or buttons that can be selected and added to the template currently being designed. The controls listed in display area 802 are provided as part of authoring tools having default functionalities previously configured. These default controls or buttons may be those commonly used or demanded. A designer may further modify the default functionality of a button, by modifying property or attributes of the control). For example, a designer may specify a contact center of the client of a control to contact a support center, rather than the one associated with the support center. Similarly, a designer can specify a particular Web site of a control to browse a knowledgebase for self-support service purposes.

In one embodiment, information displayed within second display area 802 includes a list of one or more sample templates 821 from which a designer can use as a basis to design its own template. These sample templates have been previously designed and configured to have a set of default settings that are considered most relevant to that particular template (e.g., invoice, health record, etc.). In this example, assuming the designer has selected template style 1, the default settings associated with the selected template style are displayed in third display area 803 (including billing, contact, etc.). From display area 803, the designer can include or exclude certain controls or functions into or from the template being designed in display area 801. In addition to the template styles 821, a set of action dialogs 822, support dialogs 823, and other controls or buttons 824 are also displayed in display area 802 that can be included into the template being designed. Further certain personal information such as name, address, phone number can be displayed in fourth display area 804 that can be included or excluded. Similarly, certain business process information such as deadline and payment amount can also be included or excluded. A designer can drag and drop a control into and from display area 801. FIG. 8B shows a preview of a template being designed. Note that the layout of authoring tools as shown in FIGS. 8A and 8B are described for illustration purpose only; other design layout can also be applied.

The techniques described above can be utilized in a variety of situations. For example, if a user document is related to a client in a retail space, controls added to an interactive document can be used to place or cancel an order, track orders, add or remove a product, view product list or information, purchase a product, add a credit card for purpose, address service for purchase, compare products, and request/track warranty service/support. If the user document is related to travel documents, a control added can be utilized to check or change flight/car/hotel status and compare flights/cars/hotels, etc. If the user document is related to healthcare, a control added can be utilized to review/dispute/pay bill, apply credit, add healthcare information, and add personal information.

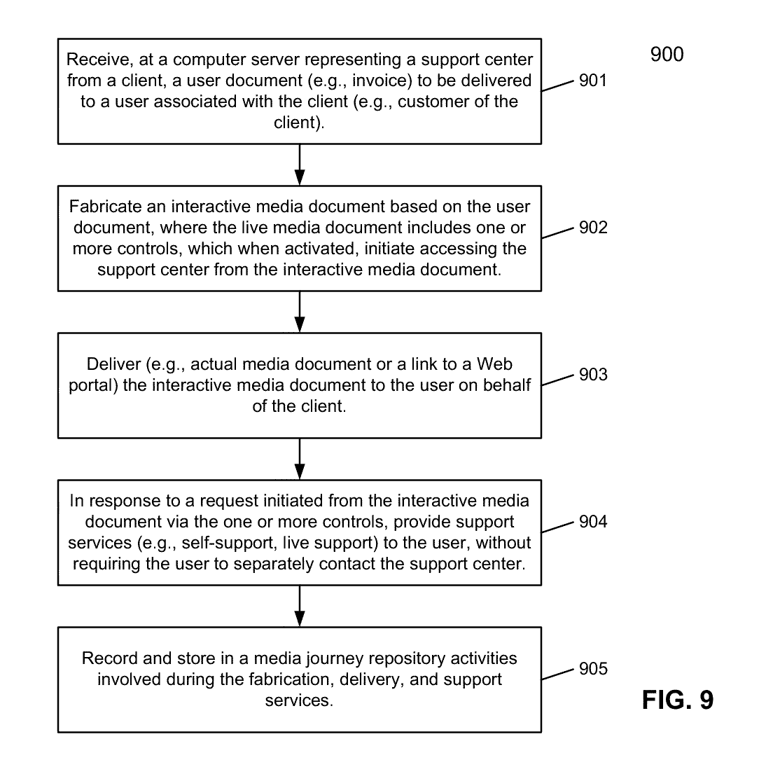

FIG. 9 is a flow diagram illustrating a method for providing support services using an interactive media document according to one embodiment of the invention. Method 900 may be performed by processing logic which may include software, hardware, or a combination thereof. For example, method 900 may be performed by media service system 104 of FIGS. 1 and 2. In one embodiment, a server representing a support center receives a user document from a client to be delivered to a user, where the user is a customer of the client and the user document contains information describing a product or service (product/service) provided by the client to the user. The support center provides support services to a plurality of products or services on behalf of a plurality of product/service providers as clients to the support center. In response, processing logic fabricates an interactive media document based on the user document, including embedding one or more controls in the interactive media document and adding additional information in the interactive media document based on information obtained from a backend system of the client. The one or more controls, when activated from the interactive media, transmit a request to the support center for obtaining support services. Processing logic then sends identifying information identifying the interactive media document to the user on behalf of the client over a network, without requiring the client to send the user document to the user, such that the user can access the interactive media document. Subsequently, the server receives a request from the user for obtaining support services concerning content of the user document, where the request was originated from an activation of one of the controls embedded in the interactive media document when the interactive media document is displayed at a remote device associated with the user. In response to the request, a live communications session is established between the remote device representing the interactive media document and a support agent associated with the support center, including routing data between the user and the support agent via the interactive media document displayed at the remote device. Processing logic monitors and stores in a media journey repository metadata describing interactive events associated with the interactive media document.

Referring to FIG. 9, at block 901, a user document (e.g., invoice, monthly statement, or health record) is received at a server associated with a support center from a client, where the user document is to be delivered to a user as a customer of the client. At block 902, processing logic fabricate an interactive media document based on the user document. The interactive media document includes one or more controls or buttons, which when activated, initiate accessing resources of the support center from the interactive media document. In one embodiment, the interactive media document is fabricated using an interactive media document template that is designed using authoring tools or platform described above. At block 903, the interactive media document is delivered to the user on behalf of the client. The media document can be physically delivered to the user via an email or alternatively, a link to a predetermined storage location (e.g., universal resource locator and/or universal resource identifier (URL/URI)) from which the user can access the media document. Dependent upon the specific circumstances, the media document may be delivered using a guaranteed delivery mechanism of which an electronic receipt can be received from the user indicating that the user indeed receives the media document, which can be tracked and stored in the media journey repository as described above. In response to a request that is initiated from the interactive media document via one or more controls displayed at a user device of the user, at block 904, processing provides support services (e.g., self-support services or live support services) to the user, without requiring the user to separately contact the support center. At block 905, the action and events during the fabrication, delivery, and support services are tracked and stored in a media journey repository.

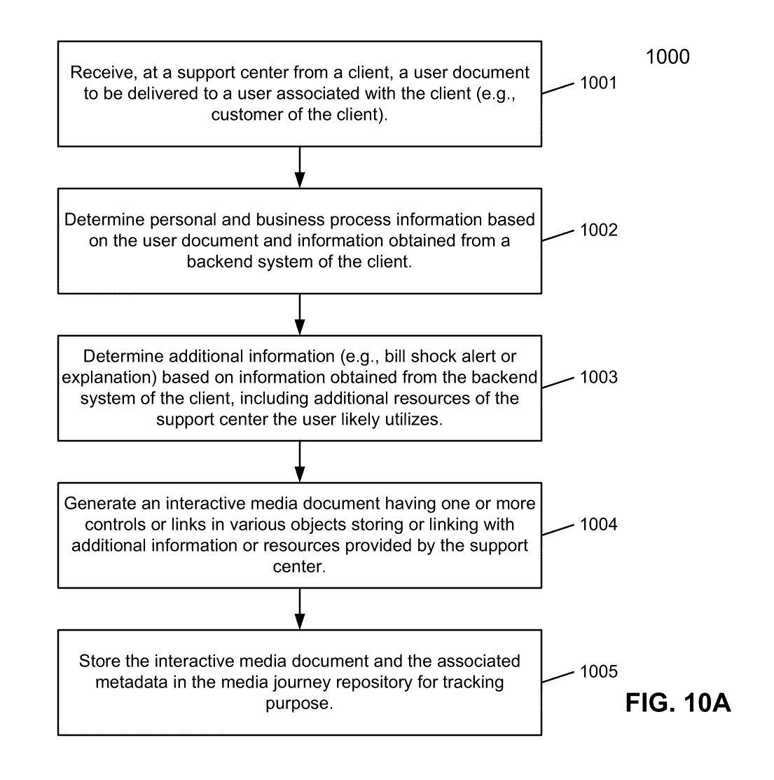

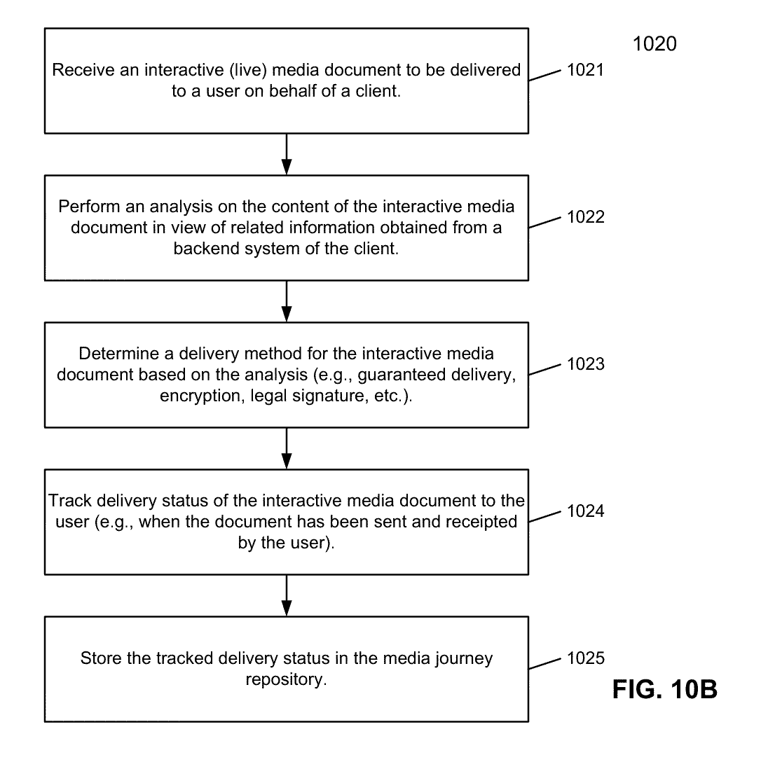

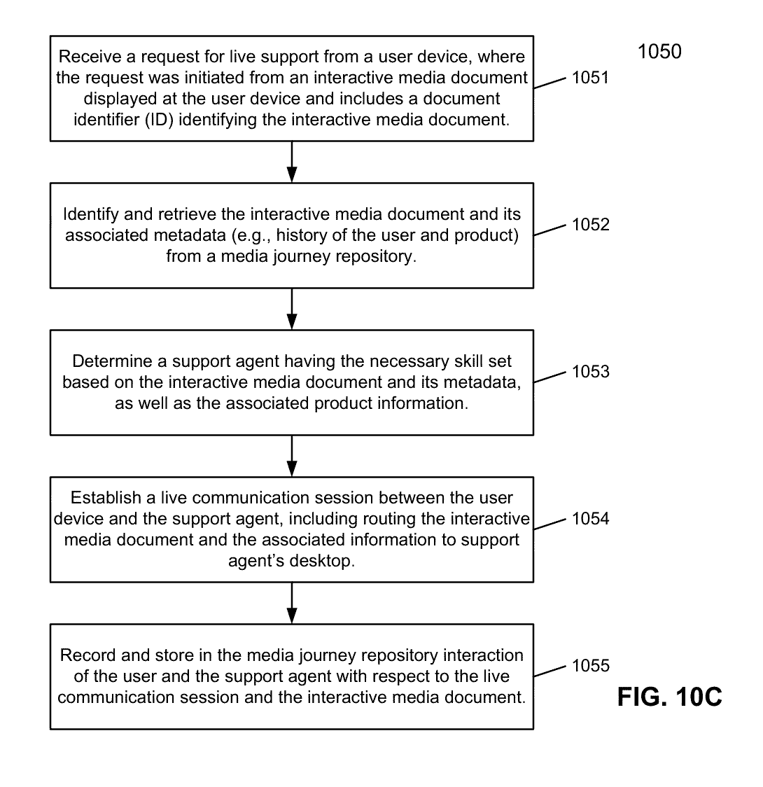

FIG. 10A is a flow diagram illustrating a method for fabricating an interactive media document according to one embodiment of the invention. Method 1000 may be performed by processing logic which may include software, hardware, or a combination thereof. For example, method 1000 may be performed by media fabricator 202 as part of operations involved in block 902 of FIG. 9. Referring to FIG. 10A, at block 1001, a user document is received at a server associated with a support center, where the user document is received from an entity associated with a client (e.g., an invoice received from a billing system of the client). At block 1001, processing logic determines at least the personal and business process information based on the user document and information obtained from a backend system of the client. At block 1003, processing logic determines additional information (e.g., bill shock alert or explanation) based on information obtained from the backend system of the client, including additional resources (e.g., controls or buttons for accessing support resources) of the support center the user likely utilities. At block 1004, processing logic generates an interactive media document having one or more controls or links in various objects storing or linking with additional information or resources provided by the support center. At block 1005, the interactive media document and the associated metadata are captured and stored in a media journey repository for tracking purpose.

FIG. 10B is flow diagram illustrating a method for delivering an interactive media document according to one embodiment of the invention. Method 1020 may be performed by processing logic which may include software, hardware, or a combination thereof. For example, method 1020 may be performed by media delivery module 203 as part of operations involved in block 903 of FIG. 9. Referring to FIG. 10B, at block 1021, processing logic receives an interactive media document, for example, from media fabricator 202, to be delivered to a user on behalf of a client of the support center. At block 1022, processing logic performs an analysis on the content of the interactive media document in view of related information obtained from a backend system of the client. At block 1023, processing logic determines a delivery method for the interactive media document based on the analysis (e.g., guaranteed delivery, encryption, disclaimer or warning, legal signature, etc.). At block 1024, the delivery status of the media document is tracked and stored in the media journey repository at block 1025.

FIG. 10C is flow diagram illustrating a method for providing support services via an interactive media document according to one embodiment of the invention. Method 1050 may be performed by processing logic which may include software, hardware, or a combination thereof. For example, method 1050 may be performed by agent service module 204 as part of operations involved in block 904 of FIG. 9. Referring to FIG. 10C, processing logic receives a request for live support (e.g., voice, video, chat) from a user device, where the request was initiated from an interactive media document media document displayed at the user device. The request includes a document ID that uniquely identifies the interactive media document. At block 1052, processing logic identifies and retrieves the interactive media document and is associated metadata from the media journey repository. At block 1053, processing logic determines a skill set required to provide such live support and identifies and selects a support agent having the required skill set. At block 1054, processing logic establishes a live communications session between a user of the user device and the selected support agent, including routing at least the user document associated with the interactive media document and the associated information to the support agent's desktop. At block 1055, the interaction between the user and the selected support agent is recorded and stored in the media journey repository for tracking purposes.

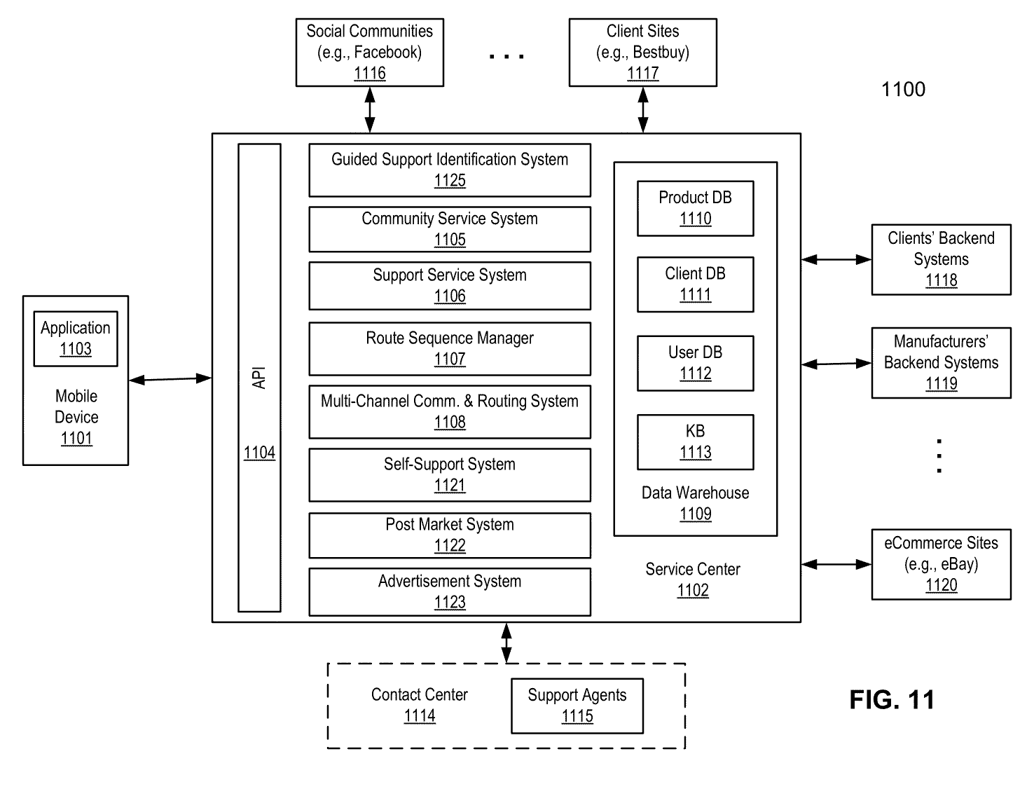

FIG. 11 is a block diagram illustrating a system for providing support services to products according to one embodiment of the invention. System 1100 can be implemented as part of systems described above. For example, service center 1102 may be implemented as part of support center 102 of FIG. 1 described above. Throughout this application, a service center is also referred to as a support center or call center.

Referring to FIG. 11, system 1100 includes a mobile device 1101 of a user, customer, or individual communicatively coupled to service center 1102 over a network. The network may be any kind of networks, such as a wide area network (WAN) (e.g., the Internet), a local area network (LAN), or a combination of both. Mobile device 1101 may be any kind of mobile devices including, but is not limited to, a laptop, mobile phone, tablet, media player, personal digital assistant or PDA, etc. Communication connections between devices can be established either by routing through the network or by direct initiation of calls from one end device to another by a mobile application communicating with a server who selects the target. For routed calls the network provides the state of the connection and hence the call state component of agent availability. For direct initiation, some device environments provide for notification of call state and others do not. The Apple® Facetime™ implementation in the iOS™ operating system, for example, allows video calls to be established by API, but does not provide subsequent information about the call. In that case we deduce whether a call has been successful and when it ends from the behavior of the operating system. A timer is set when the Facetime call is invoked by the application and examined when control is returned to the application. From the timer duration we determine whether the call was successful and when it ended. Note that throughout this application a mobile device is utilized as an example of a client device for the purposes of illustration only; other devices such as a desktop or server may also be applied herein.

Service center 1102 may be implemented in a centralized facility or server with data processing hardware. Alternatively, service center 1102 may be implemented in multiple facilities or servers in a distributed manner (e.g., cloud-based service platforms). Service center 1102 provides services to a variety of products or services from a variety of clients or vendors. For example, service center 1102 may be a caller center handling a variety of support call services on products or services for a variety of goods and service providers. A client may be a manufacturer, a distributor, a retailer, a service provider or broker, a purchasing facility (e.g., Amazon™, Expedia™, or ISIS™), or a combination thereof.

In one embodiment, service center 1102 includes one or more service application programming interfaces (APIs) 1104 to communicate, over a network, with other systems such as mobile device 1101, client's site 1117, social communities 1116, contact center 1114 including agents or experts 1115, client backend systems 1118, manufacturer backend systems 1119, eCommerce sites 1120 and other auxiliary systems (e.g., billing system). Service center 1102 can handle service requests from customers of multiple clients. For example, service center 1102 may handle customer service requests for a number of retail sales companies, sales/post sales calls for catalog sales companies, and patient follow-up contacts for health care providers. In such a structure, the service center may receive service requests directly from the customers or through client support management systems.

In one embodiment, service center 1102 further includes community service system 1105, support services system 1106, route sequence manager 1107, and data warehouse 1109. Support services system 1106 is responsible for handling support services requests from the users, including identifying and registering a product, creating an instance case context, selecting and assigning a customer representative (also referred to herein as an agent, specialist, or expert) to provide support services to the users, and managing work flows, etc. An agent may be selected based on a skill set or expertise of the agent in a skill, as well as other factors such as geographic location, of the agent. The term “agent,” “specialist,” or “expert” refers to a service center personnel or a computerized application, in some cases, that respond to customer requests. An agent may be locally situated at the service center or remotely situated over a network. Throughout this application, the terms of “agent,” “specialist,” and “expert” are interchangeable terms dependent upon the circumstances. In most cases, the term of “agent” collectively refers to a customer representative, a support agent, a support specialist, a support expert, or a combination thereof, which may be a service center personnel and/or a computerized application.

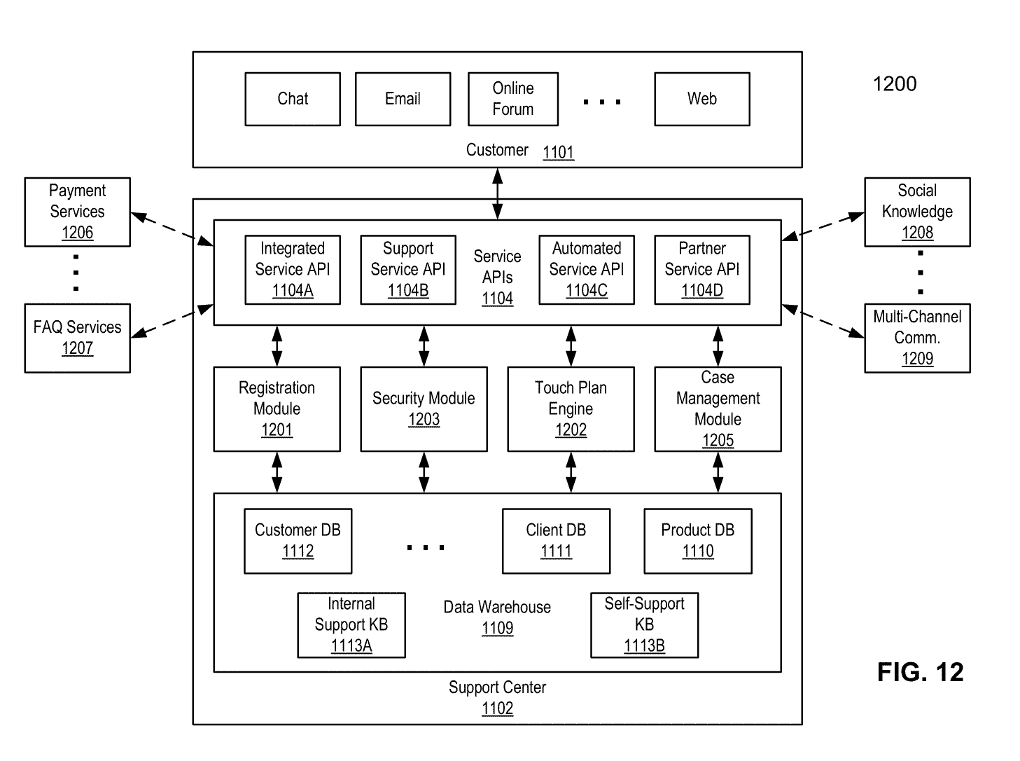

FIG. 12 is a block diagram illustrating an example of support service system of a service center according to one embodiment of the invention. For example, system 1200 may be implemented as a part of system 1100 of FIG. 11. Referring to FIG. 12, system 1200 includes service APIs 1104 to allow customer 1101 to reach support center via a variety of communication mediums such as chat, email, online forum, Web, video, voice, etc. Customer 1101 may initiate a contact with support center 1102 via a mobile application (also referred to as a one-touch application) installed on the customer's mobile device as described above. Service APIs 1104 may include a variety of subsets of APIs such as integrated service API 1104A, support service API 1104B, automated service API 1104C, and partner service API 1104D. Some or all of these APIs 1104A-1104D may be implemented as cloud-based service APIs, where the service APIs may be maintained by a third party service provider as a part of software as a server (SaaS) on a subscription basis.

In one embodiment, integrated service API 1104A may be utilized by certain integrated service providers such as payment services 1206, dispatch services, location services, tracking and delivering services, short messaging services (SMS), social networking and blogging services (e.g., Twitter™), and customer relationship management (CRM) services (e.g., Salesforce™), etc. Automated service API 1104C may be utilized by AI Artificial Intelligence services, BOT services automated services (like roBOT) that mimic the actions or activity of a human processes or activities making the user think they are talking to a live person, frequently-asked question (FAQ) services 1207, survey services, eLearning services, etc. Partner service API 1104D may be utilized by certain partner entities of the support center such as social knowledge 1208, multi-channel communication system 1209, and social CRM (e.g., Lithium™) etc.

In one embodiment, support service API 1104B can be utilized by customer 1101 to reach the support center. Support service API 1104B may be utilized, for example, via a one-touch application launched from a mobile device, to register a user, register a product, access knowledgebase (e.g., KBs 1113A-1113B), and obtain a support service from an agent, AI, BOT service, etc. Initially, when a customer downloads and installs a one-touch application on its mobile device, the customer can access support center 1102 via support service API 1104B to create a user account, which may be performed by registration module 1201. Subsequently, the customer may also log into the account via support service API 1104B, which may be authenticated by security module 1203, to register a product and/or to retrieve a list of registered one or more products that have been registered with support center, using certain techniques described above.

When there is a need to contact support center 1102 on a product, the customer can activate the one-touch application from its mobile device or press a one-touch button from a Web site, which will access and log into support center 1102 via support service API 1104B, where the customer and/or the mobile device can be authenticated by security module 1203. In addition, case management module 1205 is configured to create a unique case ID that uniquely identifies the instant support case. The case ID may be created based on a combination of at least some of the product identifiers (e.g., serial number, barcode, quick response (QR) code, high capacity color barcode (HCCB) code, receipt transaction ID), client information (e.g., retailer ID, manufacturer product ID), customer information (e.g., personal information, username, password, mobile device ID), and other information (e.g., time, date).

In one embodiment, touch plan engine 1202 is configured to create a touch plan which is identified and tracked by the case ID. The touch plan may be created according to one or more business rules or templates of the client. The touch plan represents a roadmap, an outline, a tracking record, or case context for the instant support case. The touch plan may also include or reference to other aiding information, such as, product information, product intelligence information, customer history data, client information, and manufacturer information, etc., which may be retrieved and compiled from various informational sources such as customer database 1112, client database 1111, product database 1110, knowledgebase 1113A-1113B, client and/or manufacturer backend systems, etc. The touch plan is then forwarded to an agent that has been assigned to the instant case to allow the agent to have all the necessary information to enable the agent to provide the best customer experience. The agent may be assigned based on a variety of factors, such as, skill set, expertise, demographic location, language, prior customer relationship, etc.

Data warehouse 1109 includes, but is not limited to, self-support KB 1113B, internal support KB 1113A, client database (DB) 1111, product database 1110, and customer database 1112. Internal support KB 1113A may store any support information or communications between an agent and a customer. Self-support KB 1113B contains published information extracted from other informational sources, such as internal support KB 1113A and other systems (e.g., client backend systems and manufacturer backend systems). Self-support KB 1113B allows a customer to browse in an attempt to find a solution for the customer's problem, hopefully without having to contact a live support agent. Client database 1111 may store any client related information, including a client profile for each client supported by support center 1102. For example, client database 1111 may store client's preference of communication channels to be utilized between a customer and an agent. Client database 1111 may also contain membership information of the customers.

Product information store 1110 may store any user manual or technical manual of products. Product detailed information may further include complementary products and services, availability, etc. Such information may be drawn from external systems such as client's backend systems and/or manufacturer's backend systems. Customer DB 1112 may store any customer related information such as personal information (e.g., name, address, phone numbers, sex, age), security credential, device ID of its mobile device, etc. Customer DB 1112 may store any product that has been registered by a customer. Customer DB 1112 may further store information regarding any interaction between a customer and an agent of previous support sessions, such as topics, detailed discussions, time of the discussions, contact mechanisms used, reasons of the support, products or services involved in the discussions, last agent or expert the customer interacted with, etc.

Other databases may also be included and utilized. For example, an agent or expert database may be maintained for the purpose of selecting an appropriate agent or expert in response to a support service from a customer. An agent and expert information database may include a profile for each agent or expert, respectively, that includes individual agent or expert identifier, individual name, address, communication device information, personal information (e.g., age, sex, hobbies, physical condition, spoken languages, ethnicity, geographic area of expertise, etc.), individual skills and/or areas of expertise. The agent/expert database may further include day(s) and time(s) during which and/or areas in which the agent/expert may be contacted to service customer contacts and/or a number of times over a selected period in which the agent/expert may be contacted to service customer contacts (e.g., similar to presence information).

In addition, a service statistics database may also be maintained. A service statistics database may represent any database that stores data related to the operation and management of the support center system 1102. Data such as the number of customers in queue at a certain date and time, the duration of support contact in queue, the rate of contact abandonment, and the use of communication resources are stored in the statistics database. Note that the databases and data stores are shown and described for the purposes of illustration only. These databases and data stores can be implemented or configured in a variety of configurations, which may be implemented locally or remotely over a network. Note that some databases or data stores may be implemented as a single database or store or multiple databases or stores.

In one embodiment, registration module 1201 is responsible for registering a customer and/or a product of a customer, where the customer's personal information or preferences may be stored in a customer profile store as part of customer DB 1112, while the registered product information may be stored in customer DB 1112. For example, when a customer installs a one-touch application on its mobile device, the customer typically performs an initial login to set up a user account, including a username and/or password, as well as customer's preferences (e.g., communication channel preferences). In one embodiment, registration module 1201 can also be used to assist in registering a user for other accounts such as a loyalty account across one or more loyalty programs, a rewards program, etc. This information may be stored in customer DB 1112. In addition, a unique device ID such as a MAC address or IMSI code may be captured and stored in customer DB 1112. As a result, when the customer subsequently launches the one-touch application, the customer can be automatically authenticated by security module 1203 based on this information without requiring the customer to provide the same information again.

According to one embodiment, when a one-touch application is activated or launched from a mobile device by a user, the one-touch application is configured to communicate with service API 1104. Service API 1104 invokes security module 1203 to authenticate the user based on the information (e.g., MAC or IMSI) transmitted from the one-touch application without requiring the user to specifically provide user information.

Once the user has been authenticated, according to one embodiment, service API 1104 transmits a personalized page having a list of one or more products from a customer asset store (not shown) that have been registered to the user. The list of the registered products may be displayed on a display of the mobile device, where each product is associated with one or more communication channels that are available for the user to contact an agent of the support center. In one embodiment, the availability of the communication channels is determined based on the user preference obtained from customer DB 1112 and the client/vendor preference from client database 1111 at that point in time. Such user preference and client/vendor preference may be configured in a user profile and client/vendor profile, respectively, which may be maintained by the support center.

In response to a selection of one or more of the available communication channels received at the service API, according to one embodiment, a unique case identification (ID) is instantly created by case management module 1205 to uniquely represent a current instant of the support case. In addition, a touch plan is created by touch plan engine 1202 and tracked by the unique case ID, where the touch plan represents a roadmap or outline of the corresponding support case activities to be performed throughout the life of the touch plan. The touch plan is updated regarding all activity of the user and is forwarded to an agent assigned to the current case and a communication session is established between the assigned agent and the user via the selected communication channel. Throughout the session the touch plan is updated on all activity between the user, agent and their respective applications.

An agent may be selected based on a variety of considerations, such as a skill set or expertise of the agent, as well as whether the agent has previous experience with the same customer. The touch plan may include one or more references linked with all the information related to the current instant support service, such as related product information, client information, customer information, and support history with the customer, etc., such that the agent can provide the best possible services to the customer. The touch plan may further include suggestion or prediction of products or services that the agent can provide the customer an alternative solution. The suggestion or prediction may be generated by a persuasive engine (not shown) based on the product information and the customer's interactive history, etc. The interaction between the user and the agent is logged by a logging module (not shown) and tracked based on the touch plan and the unique case ID, which may be stored in an interaction history database, for example, for subsequent analysis by an analysis module.

Processing logic associated with the touch plan (e.g., touch plan engine, case management module, or some other logic) also monitors for positive and negative activities from the user, the agent and respective applications. If a negative event is occurring the processing logic can perform adjustments according to the touch plan in knowledge provided, agent scripting spoken to the user and many others in a manner such to turn the interaction positive (e.g., adapt to changing conditions and circumstances). If the activity is positive the processing logic can provide an additional activity in and around product or service upsell, cross sell, upgrades, and product sales, etc. The positive and negative activity monitoring and adjustments are not limited to a user and agent, they can support any form of interaction even long running interactions that exceed the user activity for any period of time.

In some situations, according to one embodiment of the invention, the touch plan may include information that identifies a relationship between two products or services that have been purchased via a client (e.g., purchasing house). When a first product/service changes, the support center may determine that a second product/service may need to change as well based on the touch plan. Accordingly, a proactive service module (not shown) is configured to proactively notify the user regarding the possible change of the second product/service and offers support services for the second product/service, without requiring the user to initiate a support call. A suggestion or offer can be made to the customer by a persuasive engine based on the information obtained from databases 1111-1113 of data warehouse 1109.

According to one embodiment, prior to contacting an agent, a list of support options may be presented to the user, including a link to a publication forum that may contain one or more solutions to a problem associated with the user. Such solutions may be generated by a publication module (not shown) by extracting certain information from knowledgebase from a variety of informational sources, such as, for example, internal support KB 1113A, client/vendor KB (e.g., client database 1111 and client backend system), manufacturer KB (e.g., product database 1110 and manufacturer backend system), online community KB, and/or customer interactive history KB, etc. As a result, a user may find a solution from the publication forum and does not need to contact an agent of the support center, which in turn may lower the cost for the client and/or the customer. This is also referred to as a call avoidance feature. Certain information from data warehouse 1109 may be queried and reported by a reporting module.

Note that components or modules shown in FIG. 12 are described for the purpose of illustration only; more or fewer components or modules may also be implemented. For example, a customer satisfaction system (CSAT) may also be implemented within support center 1102. A CSAT system provides a feedback form to a customer, through a variety of communication channels at the completion of a request or a query made by the customer. The feedback form filled out and provided by customers is stored, reviewed, and analyzed by the CSAT system. All feedback forms stored in the CSAT system are used as a tool to conduct a customer service related survey. The feedback forms are, further used to enhance the service provided by support center 1102.

Referring back to FIG. 11, in one embodiment, community service system 1105 is responsible for communicating with social communities 1116 via an API, for example, to post a message received from a user and to route the responses received from social communities 1116 back to the user. Service center 1102 further includes other components such as a post market service system 1122, which is responsible for handling post market activities associated with the registered products, including selling a registered product on eCommerce sites 1120 and arranging a disposal facility to dispose or recycle the product, etc.

According to one embodiment, in addition to registering a product with the service center, a user can also register, for example, through the application running within a mobile device, one or more social communities and/or one or more eCommerce sites by storing the necessary credentials (e.g., usernames and passwords) of the servers hosting the social communities and eCommerce sites in a database (e.g., user database) of the service center, where the database is associated with a user the mobile device. Subsequently, the user can transmit a sales request to sell or dispose a registered product by specifying one or more of the eCommerce sites.

In response to the sales request, post market service system 1122 of service center 1102 is configured to retrieve the necessary credentials for the specified one or more eCommerce sites and arrange the specified eCommerce sites for selling the product together with the associated credentials to allow the eCommerce sites to authenticate the user for the purpose of selling the product, such that the user does not have to provide the necessary credentials at the point in time of the sales request and the user does not have to provide detailed information of the product to be posted on the eCommerce sites describing the product to be sold. A single sales request received from the mobile device can specify multiple eCommerce sites. The service center can also arrange a disposal facility to dispose (e.g., recycle) a registered product without having a user to specifically contact the disposal facility.

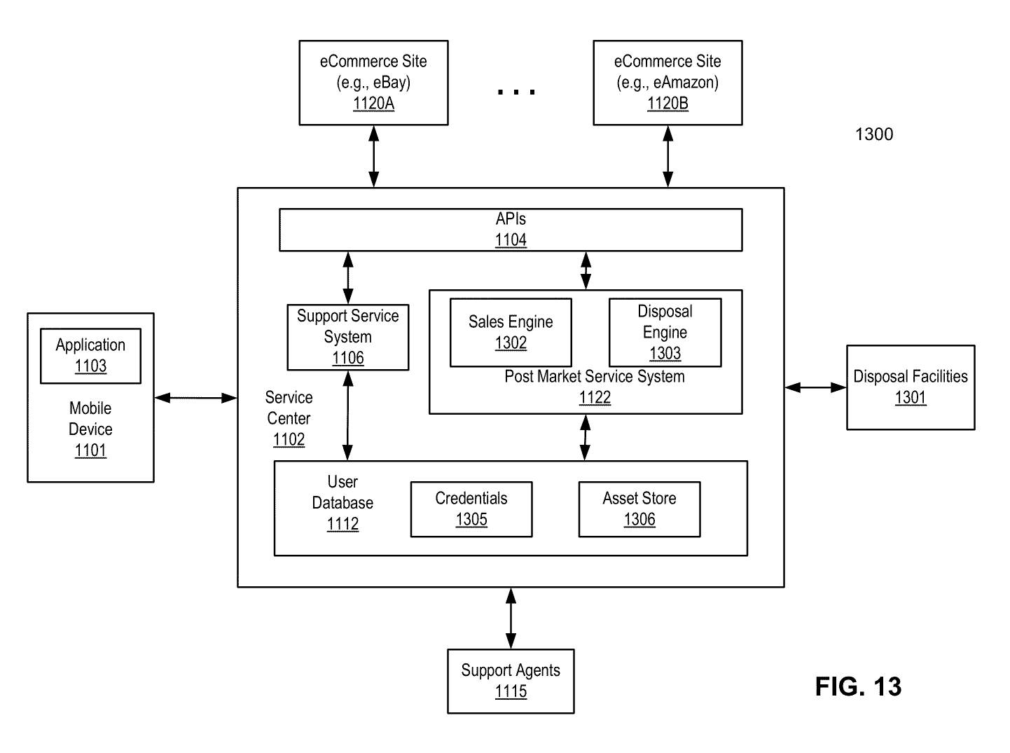

FIG. 13 is a block diagram illustrating an example of a service center according to another embodiment of the invention. For example, system 1300 may be implemented as part of system 1100 of FIG. 11. Referring to FIG. 13, as described above service center 1102 includes support service system 1106 and post market service system 1122. Support service system 1106 is configured to communicate with a user of mobile device via application 1103. Through a service API or APIs, a user can register a product with service center 1102 by scanning a machine-readable code such as a barcode, a universal product code (UPC), or a serial number of the product, for example, using a scanner or camera of mobile device and transmitting the machine-readable code to service center 1102 over a network.

Based on the machine-readable code, a registration module of support service system 1106 is configured to compile any information concerning the product without requiring the user to provide the same detailed information of the product. For example, the registration module is configured to access a variety of informational sources, such as client backend systems and manufacturer backend systems, to obtain the detailed information based on the machine-readable code, without requiring a user to provide the same detailed information.

In addition, according to one embodiment, a user can also register eCommerce sites 1120A-1120B with the service center 1102. For example, a user can provide necessary credentials that are required to access eCommerce sites 1120A-1120B and the credentials are stored in user database 1112 as part of credentials 1305. Examples of credentials 1305 include usernames and/or passwords of the user to access eCommerce sites 1120A-1120B. Credentials 1305 can be subsequently used for accessing eCommerce sites 1120A-1120B without prompting the user for the same.

As described above, support service system 1106 is configured to provide support services to a user regarding a registered product stored in asset store 1306. For example, in response to a request for support services of a registered product received from application 1103 of mobile device 1101, support service system 1106 is configured to establish a communications session between a user of mobile device 1101 and one of agents 1115 using one or more communications channels (e.g., voice, email, chat, video, etc.) that are preferred by the user and are available to the agent. The preference of the communications channels may be previously configured or registered with service center 1102 by the user and such preferences may also be stored in a preference store (note shown) of user database 1112.

According to one embodiment, post market system 1122 includes a sales engine 1302 and disposal engine 1303. Sales engine 1302 is responsible for selling a registered product from asset store 1306 on at least one of eCommerce sites 1120A-1120B. In one embodiment, a user can utilize application 1103 of mobile device to send a request to service center 1102 for selling a registered product. The request may simply identify a registered product with a listing price and one or more identifiers identifying one or more of eCommerce sites 1120A-1120B for selling the product, without having to provide other detailed information such as detailed product information and necessary credentials for accessing the social community sites 1120A-1120B.

In response to the request, sales engine 1302 is configured to retrieve the necessary credentials 1305 required to access eCommerce sites 1120A-1120B and the necessary product information (e.g., description or specification, etc.) from the product database and/or client database. Sales engine 1302 then transmits the product information, listing price, and the associated credentials to the specified eCommerce sites 1120A-1120B via API 1104. API 1104 may include specific APIs for accessing different eCommerce sites using a variety of communications protocols.

The eCommerce sites 1120A-1120B can authenticate the user based on the received credentials without requiring service center 1102 to prompt the user for the same credentials at the time of submitting the sales. Upon having successfully authenticated the user, the sales of the product may be posted on the eCommerce sites 1120A-1120B based on the received product information and the listing price. In one embodiment, a single request from mobile device 101 can be used to post a sales item on multiple eCommerce sites 1120A-1120B without having the user to submit the sales item multiple times. Sales engine 1302 is configured to coordinate the sales transactions among eCommerce sites 1120A-1120B, for example, to prevent the same item to be sold on multiple sites, etc. For example, when an item has been sold on a first site, the listing of the same item will be withdrawn from a second site.

In one embodiment, service center 1102 can also perform or invoke another entity to perform market survey concerning current market conditions of a product, for example, based on operating conditions of the product at the point in time, which may be provided by a user. Based on the survey, service center 1102 can provide an estimated market value of a registered product and transmit the estimated value to mobile device 1101 and displayed by application 1103. The estimated market value of the product can help the user to set a selling price.

According to another embodiment, service center 1102 can also promote or suggest other products (e.g., accessories) related to the registered products to the user and provide a purchasing platform to allow a user to purchase the related products. The purchasing functionality may be implemented as part of sales engine 1302 or a separate component. Once a product is purchased via service center 1102, the purchased product is automatically registered within service center 1102 without the user to specifically register the product, for example, based on the product information and/or client information obtained from manufacturer and/or client backend systems.

Note that a manufacturer or retailer often wishes to promote or reward a customer who purchased its product or subscribed its loyalty program. Alternatively, a manufacturer or retailer may also notify a user concerning a recall of user's products. Such a promotion, reward, or notice may be received by service center 102 from a variety of sources such as manufacturers and retailers. Service center 1102 can associate such a promotion or reward with a registered product and transmit such a promotion or reward to mobile device 1101 as a suggestion to the user. As a result, service center 1102 enables the manufacturers or retailers to reach their customers, similar to targeted advertisement. Meanwhile, a user does not have to browse around in order to find out any product upgrades or product recall associated its registered products. The user can simply rely on service center 1102 for such services.

According to another embodiment, disposal engine 1303 is configured to arrange disposal facilities 1301 to dispose a registered product if the user no longer wishes to maintain the product. In this situation, a user does not have to individually find out who can dispose or recycle a particular type of products. Instead, the user can initiate a request from mobile device 1101 requesting disposal of a registered product. In response to the request, disposal engine 1303 is configured to determine a particular one of disposal facilities 1301 that is capable of disposing or recycling the requested product and to transmit the information of the selected one of disposal facilities 1301 to allow the user to contact the selected disposal facility or alternatively, disposal engine 1303 can establish a communications sessions between the user and a customer representative from the selected disposal facility, for example, using a communications channel preferred by the user and available to the customer representative. Thus, service center 1102 is able to provide a single platform capable of providing product registration, support, buying and selling, and disposal, i.e., a full life cycle support of a product.

Referring back to FIG. 11, according to one embodiment, a user can also post a message to one or more of the registered social communities from the application running within the mobile device without having to individually access the social communities. In one embodiment, a user can transmit a request from mobile device 1101 to service center 1102, where the request includes a message to be posted and one or more community identifiers identifying one or more registered social communities. In response, community service system 1105 of service center 1102 is configured to retrieve the associated credentials from the database and to post the message to the specified social communities together with the associated credentials allow the social communities to authenticate the user, without having to prompt the user for the same credentials.

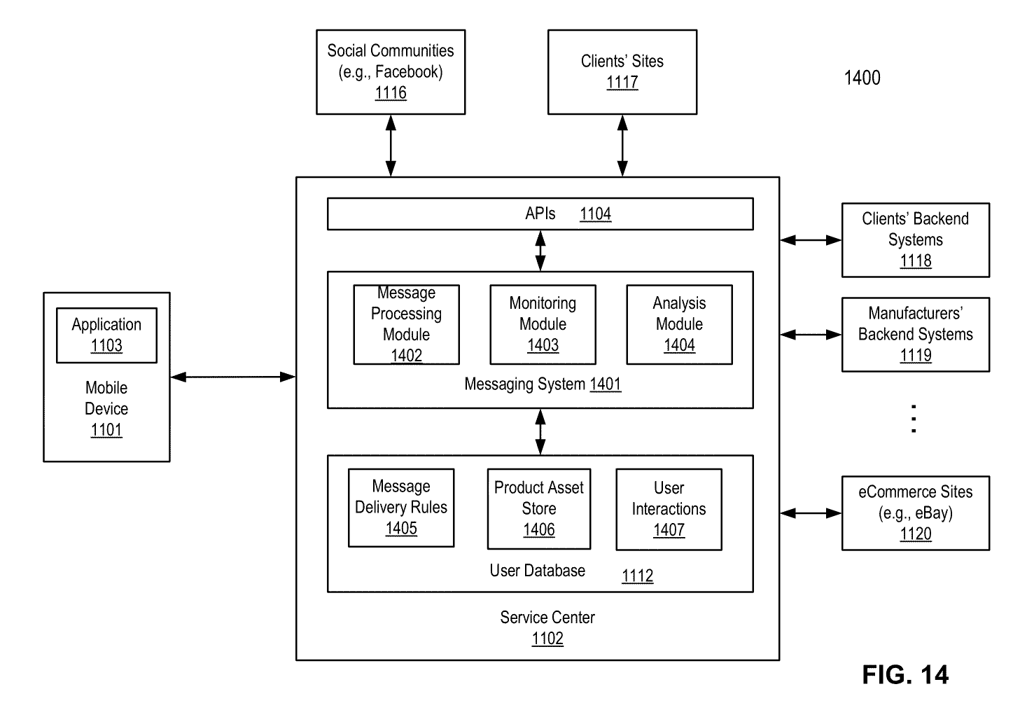

FIG. 14 is a block diagram illustrating a system for processing messages within a service center according to one embodiment of the invention. System 1400 may be implemented as part of system 1100 of FIG. 11. Referring to FIG. 14, service center 1102 includes messaging system 1401 to receive messages, via one or more APIs 1104, from a variety of sources, such as social communities 1116, client sites 1117, client backend systems 1118, manufacturer backend systems 1119, and eCommerce sites 1120. The messages may or may not be related to the registered products stored in asset store 1406 of user database 1112 associated with the registered users. For example, a message may be an advertisement received from a retailer or manufacturer, including, but is not limited to, a promotion of a related product or accessory to a registered product, a discount coupon, an upgrade, or a service schedule reminder, etc. Alternatively, a message may be a recall notification concerning a registered product of a user.

In one embodiment, a user can configure a set of one or more delivery rules 1405 specifying whether a particular type of messages or advertisements should be routed to the user. Delivery rules 1405 may also specify whether a message or a particular type of messages associated with a particular registered product should be received by the user. Delivery rules 1405 can also specify whether a message received from a particular source should be forwarded to the user. In one embodiment, certain types of messages are not available to be filtered out. For example, any recall message of any registered product must be routed to users, regardless of the configuration of delivery rules 1405. A message may be routed to a user using one or more communications channels configured by the user as communications preference, which may also be stored in user database 1112.

A message may include an advertisement of products and/or services for a consumer or user delivered via a traditional advertisement service such as Google®, etc. A message may include an offer to a customer provided directly from a manufacturer, loyalty provider, etc., where an offer may be all offers for a product line or only for products registered, or a wish list via the service center. A message may include a social feed received from a variety of social communities. A social feed may be related to user community feedback, comments, suggestions or experience of a particular product or service discussed by their community members or friends.

In one embodiment, in response to a message received one of sources 1116-1120, message processing module 1402 is configured to determine whether the message should be delivered to a user associated with mobile device 1101 based on a set of delivery rules 1405 associated with the user. If delivery rules 1405 permit, the message is routed to mobile device 1101 or one of other devices associated with the user dependent upon the settings of the communications channel preference (not shown). As described above, message may be related to a registered product specified in asset store 1406 of the user. Alternatively, the message may be related to other products or services that are likely interesting to the user, for example, based on user's interactive history, habits, and/or registered products or services, which may be captured and determined over a period of time by monitoring module 1403 and/or analysis module 204 and stored as part of user interactions 1407.

According to one embodiment, a user of mobile device 1101 can set its preference via application 1103 for any messages, advertisements, offers, or feeds that would be presented to mobile device 1101. Application 1103 provides user friendly GUIs to allow the user to specify the message delivery preferences, including manufacturer offers (e.g., product or service offers from a variety of manufacturers such as Dell®, Samsung®, etc.), loyalty offers (e.g., products or services offers from a variety of loyalty or brand providers such as Best Buy®), social feeds (e.g., feeds based on products from social communities such as Facebook® or Twitter®), and other advertisement providers. For each of the message sources, in one embodiment, a user can turn off message delivery for the particular source, turn on the message delivery only for the products registered by the user (e.g., registered products or wish list), or turn on the message delivery for all products provided by the particular source, regardless whether such products have been registered.

Referring back to FIG. 11, in one embodiment, service center 1102 further includes a messaging or advertisement system 1123 responsible for handling any messages received from a variety of partners or parties, such as client sites 1117, client backend systems 1118, manufacturer backend systems 1119, and eCommerce sites 1120. Messages may be related to the registered products of the user, such as, promotions, rewards, and recall messages. Messages may include advertisements from a variety of advertisement providers.

In one embodiment, a user can configure a set of one or more rules to specify whether certain types of messages or advertisements received from vendors or parties (e.g., retailers, manufacturers, social communities, or other advertisement providers), which may or may not be related to a registered product, should be routed to the user. These rules serve as part of message delivery or filtering rules. The service center engages with the related parties to allow the related parties to get in touch with the user by sending certain messages such as product promotions, rewards, and/or recalls, etc. to the user. The service center may send a message to a user via one or more communications channels preferred by the user, which may also be configured as a set of rules and stored in a database associated with the user.

According to another embodiment, an advertisement received from a vendor is delivered by the service center to a mobile device of a user based on a set of delivery rules associated with the user. The advertisement is displayed on a display of the mobile device by an application running therein. In addition, the service center and/or the application are configured to track interactions of the user with respect to the displayed advertisement to determine user behaviors, patterns, or trends in view of the displayed advertisement. An analysis is performed on the user interaction and the result of the analysis may be utilized to configure further advertisement delivery by the service center and/or the vendors.

According to another embodiment, service center 1102 is configured to identify users that have at least one common product registered with the service center and are also members of a social community. The service center is configured to send a message to those users to invite them to connect (e.g., becoming friends or following a friend) with each other via the social community. The social community is hosted by a third party and communicatively coupled to the service center over a network. The service center may also deliver messages or items posted by one of those users to another one of those users on behalf of the social community, without requiring such users to individually or directly accessing the social community. The service center can also deliver messages or items to a particular user posted by other users of the social community, where the messages or items are related to a registered product of that particular user.

According to a further embodiment, an application running on a mobile device provides a user friendly graphical user interface (GUI) to allow a user to configure a set of one or more delivery rules concerning whether certain types of messages or advertisements should be received at the mobile device from a service center. The service center is configured to deliver messages or advertisements on behalf of a message or advertisement provider, which can be a client to the service center, a retailer, a manufacturer, a social community, or other content providers. A user can utilize the GUI to configure, for each of the providers, whether a message associated with a particular registered product of the user or all products in general related to the provider should be received by the mobile device. The settings of the delivery rules are then transmitted from the mobile device to the service center to allow the service center to deliver subsequent messages or advertisements on behalf of the message or advertisement providers accordingly.

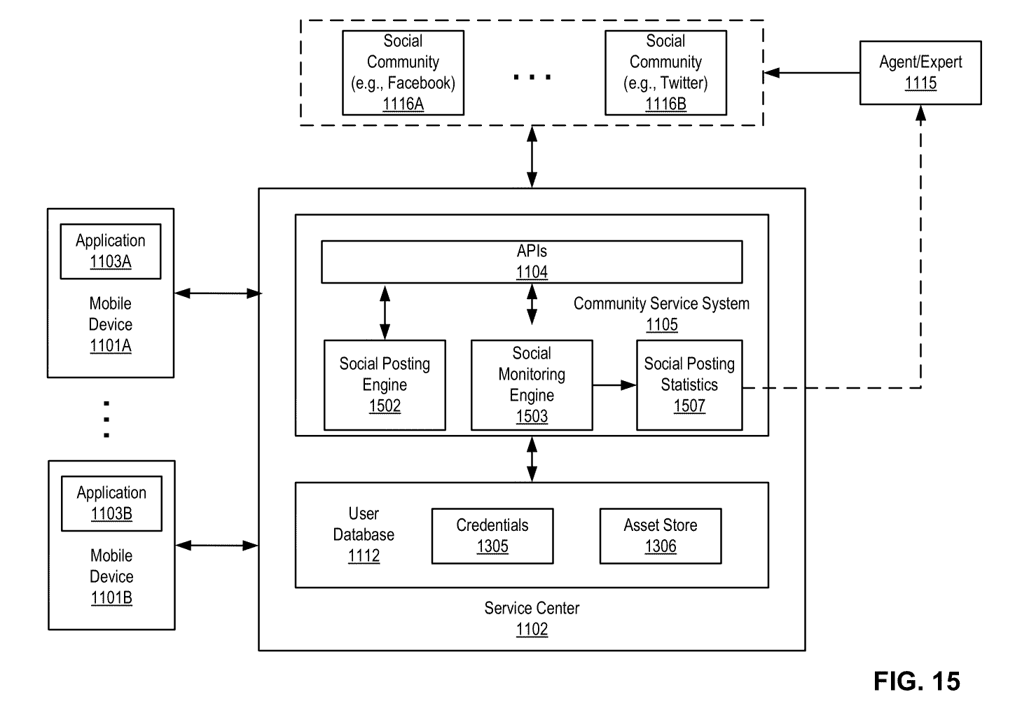

FIG. 15 is a block diagram illustrating a service center having a social community accessing platform according to one embodiment of the invention. Referring to FIG. 15, in one embodiment, community service system 1105 includes, but is not limited to, social posting engine 1502 and social monitoring engine 1503 communicatively coupled to social communities 1116A-1116B via APIs 1104. APIs 1104 may be implemented as a common API or separate APIs for accessing social communities 1116A-1116B, using a variety of communications protocols such as TCP/IP or proprietary protocols. Social posting engine 1502 allows a user to post a message via application 1103 of mobile device 1101 to one or more of social communities 1116A-1116B without having to leave application 103 of mobile device 1101.

According to one embodiment, when a user wishes to post a message to one or more of social communities 1116A-1116B, the user can create a message on a GUI page of application 103 and specify the social community or communities. The request for posting a message is then transmitted from mobile device 1101 to service center 1102 and received by social posting engine 1502. In one embodiment, the request includes information identifying a message to be posted, one or more social communities in which the message is to be posted, and a registered product associated with the posting. Based on the request, social posting engine 1502 is configured to retrieve the necessary credentials from credential store 1305 for accessing the social communities. The credentials for accessing social communities 1116A-1116B may be previously registered with service center 1102 and stored in credential store 1305. Examples of the credentials 1305 may include usernames and passwords.

Based on the registered product, social posting engine 1502 can also identify one or more discussion threads or forums of social communities 1116A-1116B that are associated with the product. Thereafter, social posting engine 1502 transmits via APIs 1104 the message and the necessary credentials to one or more of social communities 1116A-1116B for the purpose of posting the message. If a connection to a social community is unavailable at the point in time, social posting engine 1502 may store the post in a queue (not shown) until the connection becomes available. As a result, a user does not have to provide the necessary credentials to service center 1102 at the time of posting. The user may not have to identify which of the discussion forums or discussion threads in which the message should be posted. All the user needs is to specify which of the social communities and the product associated with the posting.

Similarly, when a response is received from social communities 1116A-1116B in response to the posted message, a social posting engine (not shown) is configured to route the response back to mobile device 1101. Alternatively, the response may be routed to the user according to one or more communications channels preferred by the user, which may be configured previously and stored in user database 1112 (e.g., user profile). Thus, a single message can be posted onto multiple accounts of the same social community. A single message can also be posted onto multiple accounts across multiple social communities. A social community can be hosted or maintained by a third-party social networking provider (e.g., Facebook®, Twitter®), a retailer (e.g., Amazon®, Bestbuy®), or a manufacturer (e.g., Samsung®).

According to one embodiment, community service system 1105 further includes social monitoring engine 1503 configured to monitor message postings to social communities 1116A-1116B via social posting engine 1502 and the responses received from social communities 1116A-1116B. In one embodiment social monitoring engine 1503 is configured to collect data concerning all the social posting activities. The data collection may include, but is not limited to, user IDs and date and time of post, communities the pose is made to, user accounts post is being made to, user account the post is being made from, device the post is being made from (e.g., mobile, tablet, Web), etc. Based on the monitoring, social posting statistics 1507 can be generated. In one embodiment, social posting statistics 1507 includes, but is not limited to, a number of posts by time and day, number of posts by day of week, number of users creating posts, number of products with posts, number of brands or loyalty with posts, and products least posted about, etc.

In one embodiment, an enhanced analysis may be performed on the collected data and statistics to identify trends, activities based on events, including, but not limited to, most social channels used to post, the types of accounts (e.g., user accounts, manufacturers/loyalty accounts or both) of the posts, products associated with the posts, services associated with the posts, the brands associated with the posts, number of the posts by products and services, and times of day and days of week of the posts, etc.

Social monitoring engine 1503 is configured to monitor a social environment gathering data about topics posted in communities 1116A-1116B. In one embodiment, social monitoring engine 1503 is configured to identify posts that have both positive and/or negative sentiments regarding a product or brand. Social monitoring engine 1503 may also identify activities based on either the positive or negative sentiment such as whether the traffic is heavy on the topic, whether a positive sentiment is trending negative, and whether a negative sentiment is trending positive. Social monitoring engine 1503 may also determine other social community sites that are discussing the same or similar topics or trends. Social monitoring engine 1503 may also determine the most active users participating in the community and/or whether the community is working to find a solution or the community needs an assistance to move forward. The sentiment data or social statistics 1507 can be utilized by agent/expert/specialist 1115 to participate in the discussion, for example, by interjecting comments into a negative discussion and attempting to turn it positive, or identifying a solution that the community has found to be positive and posts to other communities that may not have knowledge of the resolution. The solution or comments posted in a discussion forum may also be converted into knowledgebase for future references.

In one embodiment, based on the monitoring, a user having participated in a discussion and posted positive comments about a product may be rewarded by the service center, a retailer, and/or a manufacturer associated with the product. A user having posted a negative comment about a product may be contacted by an agent, expert, or specialist to resolve the issues in an attempt to turn the negative experience into a positive one.

Referring back to FIG. 11, according to one embodiment, service center 1102 further includes a self-support system 1121 to allow a user to access self-support knowledgebase (KB) such as KB 1113 to find a solution to its problem without having to invoke a live support with a support agent. Self-support system 1121 may be implemented as a standalone Web server communicatively coupled to service center 1102 over a network. In one embodiment, self-support system 1121 further includes a learning system to provide a series of courses to allow a user to gain training without having to have a live course on behalf of a client.

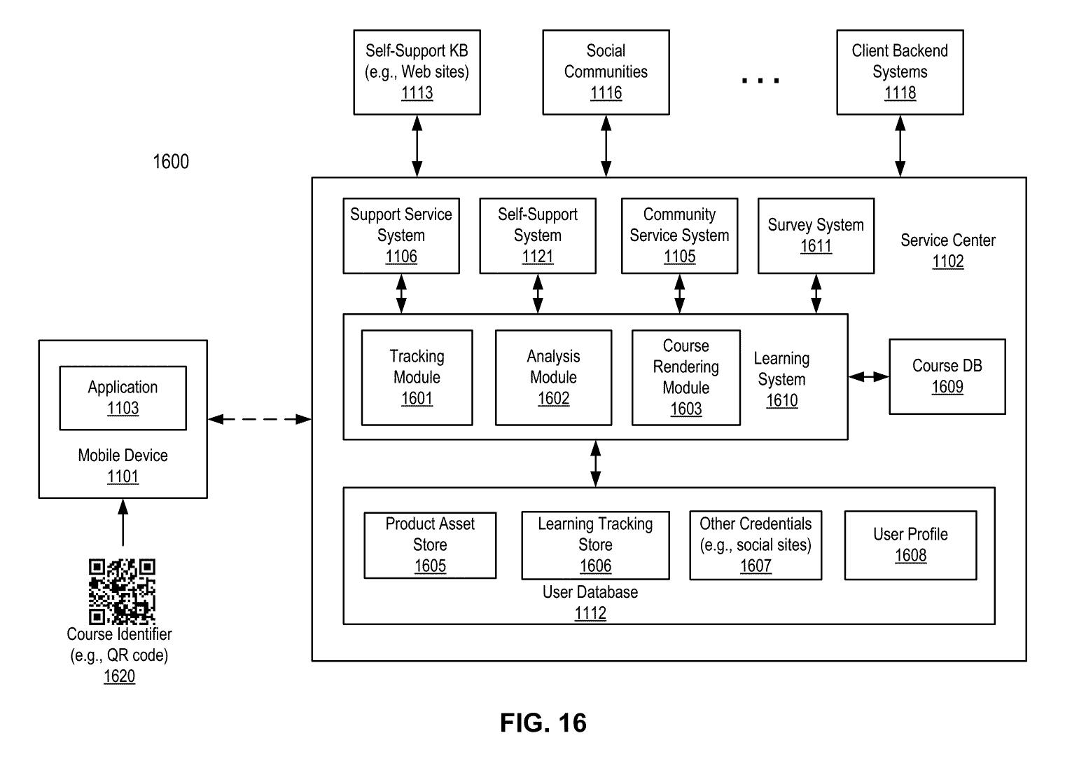

FIG. 16 is a block diagram illustrating a learning system of a service center according to one embodiment of the invention. System 1600 may be implemented as part of system 1100 of FIG. 11. Referring to FIG. 16, according to one embodiment, learning system 1610 includes tracking module 1601, analysis module 1602, and course rendering module 1603, which are configured to provide learning or training courses compiled in course database 1609 to a customer such as user of mobile device 1101. The courses are provided to users by learning system 1610 on behalf of a product provider that provides the product described by the learning course.

In one embodiment, in response to a request for accessing an online course, course rendering module 1603 of learning system 1610 identifies, renders, and transmits a course segment to a remote device of a user. The request may include a machine-readable code (e.g., QR code) that is obtained via mobile device 1101 of the user by scanning machine-readable code 1620 disposed on a product using a scanner or camera of mobile device 1101. Machine-readable code 1620 can be a variety of codes such as a QR code, a serial number, a UPC code, a barcode, an image, etc. The course or courses are identified from course database 1609 based on machine-readable code 1620 without having the user to specifically provide detailed information identifying the courses.

For example, the user can use its mobile device to scan a product identification code on the exterior surface of the product and access the courses provided by learning system 1610. Note that the product in question does not have to be a registered product; it could just be a product that may be potentially purchased by the user, as long as the user is a registered member of service center 1102 and/or a product provider of the product in question is a client of service center 102.

Based on machine-readable code 1620 received from mobile device 1101, according to one embodiment, functional capabilities (e.g., display resolution, network bandwidth, processing power, current geographic location of the device, etc.) of mobile device 1101 may be automatically determined by service center 1102, for example, without user intervention. Some of the device information may be collected when mobile device 1101 was registered with service center 1102 by the user. The courses may be rendered (e.g., in a form of a media stream) by course rendering module 1603 in view of the capabilities of the mobile device such that the courses can be properly presented by mobile device 1101. The courses may also be rendered based on user's previous learning actions. For example, based on the machine-readable code, course rendering module 1603 is configured to determine the previous endpoint of a course segment and to render a course segment having a starting point that will “pick up” the previous endpoint, such that the user does not have to repeat the previously viewed content. The user learning history may be monitored and tracked by tracking module 201.

While the user navigates the course segment, according to one embodiment, user interaction with the course is tracked and captured by tracking module 1601 of service center 1102. The user interaction may be monitored and tracked by application 1103 running at mobile device 1101 and periodically transmitted from mobile device 1101 to learning system 1610 of service center 1102 over a network. In one embodiment, analysis module 1602 is configured to perform an analysis on the tracking data and to generate an analysis report. The analysis report may be provided to a product provider to allow the product provider to determine customer satisfaction or other product and marketing purposes (e.g., targeted advertisements). In this situation, a product provider is a client of service center 1102 and the analysis report may be transmitted to the client such as client backend systems 1118. Alternatively, analysis module 1602 may invoke a customer satisfaction (CSAT) system, which may be maintained within service center 1102 or by a remote third party vendor, to compute a customer satisfaction metrics and provide the customer satisfaction metrics to the client.

In one embodiment, based on the analysis, a new or related product is identified and recommended to the user. If the user decides to acquire the recommended product, service center 1102 may allow the user to access an eCommerce site to acquire the recommended product. Service center 1102 is configured to automatically register the product and store the registered product information in product asset store 1605 associated with the user.

In one embodiment, based on the analysis, course rendering module 1603 is configured to customize or generate further courses for the user or for other users who may have similar concerns. The analysis report can also be utilized to generate a new article or modify an existing article of a self-support knowledgebase (e.g., a Web site hosting solutions to common issues such as frequently asked questions or FAQ). The analysis report may also be utilized to update or spin off a discussion thread for further discussion in an online community or social community via community service system 1105.

According to one embodiment, a course is presented in a manner such that a user can get in touch with an agent for live support, a specialist associated with a self-support knowledgebase, and/or a friend of a social community to further engage discussions of topics associated with the course and/or the associated product. In one embodiment, if the user is unsatisfied with a description of a particular course, the user can instantly activate an embedded control (e.g., a button or a link) at a particular place in time to request a further assistance or access additional information related to the course. For example, during or at the end of a learning segment, survey system 1611 may transmit a survey inquiry to mobile device 1101 to prompt the user whether the user is satisfied with the particular learning segment and collect the user response for further analysis. Meanwhile, one or more buttons or links are presented to the user to allow the user to initiate a further action.

For example, while navigating a course according to one embodiment, a user can activate a control or button embedded or associated with the course to request a live support with an agent or specialist. Based on the request received at the service center and the tracking data collected during the course, support service system 1106 is configured to identify and select an agent who is familiar with the description of the course and/or the product in question to get in touch with the user via a communications channel (e.g., voice, chat, email) that is preferred by the user (e.g., based on user preference previously configured and stored as part of a user profile) and is available (e.g., based on a configuration of a client that is associated with the course) to the agent. In addition, support service system 1106 is configured to compile all the necessary information concerning the user (e.g., user preference, user interactive history), the product in question, the learning course currently presented to the user, as well as the tracking data of the learning course collected by tracking module 1601 and the analysis performed by analysis module 1602, generating a support session context. Support service system 106 then transmits the support session context to the selected agent to be available at the desktop of the agent, such that the agent has all the necessary information during a live support session.

Alternatively, the user can activate a control or button from the course to request accessing a self-support knowledgebase (e.g., Web site) for a particular article that is related to the content of the course. In response to the request, self-support system 1121 is configured to identify one or more articles that are related to content of the learning course segment at the point in time from a self-support knowledgebase hosted by a knowledgebase server such as a Web server. The one or more articles may be identified based on the tracking data of the learning course collected by tracking module 1601 and the analysis performed by analysis module 1602. Self-support system 1121 is configured to transmit one or more links referencing the articles to mobile device 1101 such that the user can access the articles via the links from mobile device 1101. Self-support system 1121 and learning system 1610 may be implemented as a single system. In addition according to one embodiment, from the self-support articles, the user can also initiate a live support session with an agent of service center 1102 via a link or button presented along with the articles. Alternatively, from the self-support articles, the user can access a related discussion forum hosted by an online community via community service system 1105. Furthermore, since the user accesses the community via self-support system 1121, the user interaction with the articles can be pinpointed and tracked by the self-support system and fed back to service center 1102 for further analysis. For example, based on the user interaction with the learning course and self-support articles, self-support system 1121 is configured to generate further self-support articles to be posted in the self-support knowledgebase.

Furthermore, a user can also activate a control or button from the course to request access or participation in a discussion forum of an online community that is related to content of the course. In response to the request, community service system 1105 is configured to identify a discussion thread that is hosted by an online community and related to the content of the course at the point in time. Community service system 1105 transmits information regarding the discussion thread to mobile device 1101. According to one embodiment, community service system 1105 may automatically log into the online community on behalf of the user using the corresponding credentials (e.g., username and password) that have been previously provided to service center 1102 and stored as part of database 1609. As a result, the user does not have to provide the same at the point in time.

Alternatively, according to another embodiment, the user can also share the course segment with its friends in an online community. For example, the user can activate a “share” button on a graphical user interface presenting the course to request sharing the course segment. In response to the request, community service system 1105 is configured to log in and access the online community and to request the sharing of the course by transmitting a link of the course to the online community on behalf of the user. In this way, the user does not have to individually access the online community in which the user has to launch another browser session and provide the necessary credentials in order to log into the online community, which sometimes is inconvenient. Furthermore, since the user accesses the community via community service system 1105, the user interaction with the community can be pinpointed and tracked by the community and provided back to service center 1102 for further analysis as described above.

Referring back to FIG. 11, according to one embodiment, service center 1102 further includes guided support identification system 1125 configured to analyze user interaction or behaviors to predict or determine a support subject matter that a user may potentially need. Such a support subject matter may be determined based on user interaction while a user is navigating a presentation provided by a remote device such as a Web site or an application running at computing device 1101, where the presentation (e.g., application 1103) includes information describing a possible solution to a problem of a product or service, which may be related to or similar to a product or service the user is interested in.

The user interaction may be captured (e.g., by a capturing logic integrated within or accessible by the presentation) at the remote device and transmitted to guided support identification system 1125 over a network while the user is navigating the presentation at remote device 1101. Based on the predicted subject matter (also referred to as a support type), a skill set (also referred to as a skill route) that is required to provide support services of the subject matter is identified. When the user subsequently requests a live support, for example, within the same user session, an agent having the identified skill set is selected to provide support services to the user. The user interaction may be periodically captured and transmitted to the service center during navigation of the presentation. In response, guided support identification system 1125 is configured to automatically update and maintain the subject matter determined based on the latest user interaction prior to the user's request for a live support.

As a result, the guided support identification system is able to get users in need of assistance to a specific skill or expert specialist that is able to support their request or need, even before the user initiates a live support. Once the support subject matter and the required skill set have been identified, a route context (e.g., touch plan) can be generated by support service system 1106, where the routing context includes all the necessary information an agent needs in order to provide the best support services to the user. Such an agent is referred to herein as a recommended agent recommended by the service center. A communications session is then established by multi-channel communications and routing system 1108 and the routing context is routed to the selected agent.

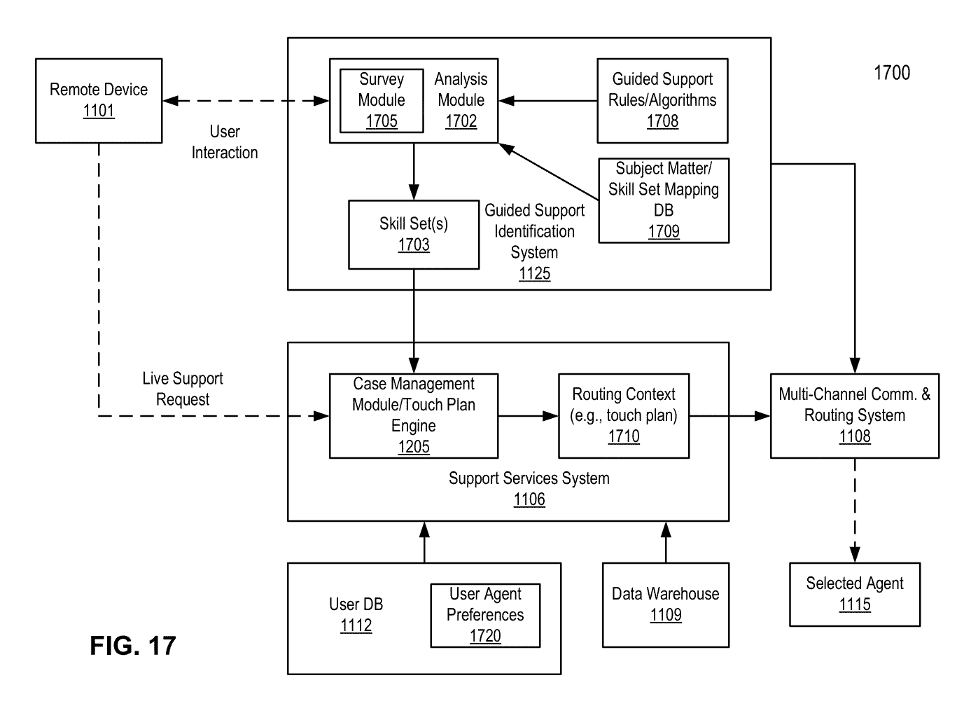

FIG. 17 is a block diagram illustrating an example of a guided support identification system according to one embodiment of the invention. Referring to FIG. 17, in one embodiment, guided support identification system 1125 includes analysis module 1702 to analyze user interaction with a presentation which may be captured at remote device 1101. Remote device 1101 may be a mobile device having an application running therein or a Web server hosting a Web page. The presentation presented by the application or Web page may include information describing a possible solution to a problem related to a product or service. In response to the user interaction, analysis module 1702 is configured to analyze and determine a support subject matter (e.g., support type) based on guided support rules or algorithms that the user may be interested in.

Guided support rules or algorithms 1708 may be designed and configured specifically tailored to the representation currently navigated by the user at remote device 1101. For example, guided support rules or algorithms 1708 may specify the overall support subject matter for the topic of the presentation. Guided support rules or algorithms 1708 may also include specific support subject matters for different parts, links, or paths within the presentation. When a user interacts with a different section of the presentation, it may yield a different support subject matter. In one embodiment, the captured user interaction may further include an amount of time the user has spent on a specific section of the presentation. Such an amount of time may be utilized as a weight factor in deciding which of the support subject matters will prevail.

Once the support subject matter has been determined, analysis module 1702 is configured to determine one or more skill set 1703 that are required to provide the associated support services based on support subject matter and skill set mapping database or table 1709. The skill set 1703 may be utilized to identify one or more agents to be recommended to the user of remote device 1101 as recommended agents. Subject matter and skill set mapping table 1709 includes information identifying one or more skill sets that are required to provide support services for a particular support subject matter. Subject matter and skill set mapping table 1709 may optionally include information identifying one or more agents or specialists that qualify for each of the skill sets.

In addition, according to one embodiment, user agent preferences 1720 are maintained in user database 1112 associated with a user. That is, each user has its own agent preferences, respectively, for example, dependent upon previous experience of previous support sessions. Agent preferences 1720 include a variety of information concerning the agents known to a particular user, such as, agent identifiers, ratings (e.g., ratings rated by all users in general and/or a specific rating rated by the particular user), and/or other information (e.g., history, products, subject matters, etc.).

When the user initiates a live support from remote device 1101, for example, by activating a support button or control from the presentation after navigating the presentation, a live support request is received by support service system 1106. This could be a situation in which after the user has navigated a certain section of the presentation, the user does not quite understand or is not satisfied with the description. The user may want to have a live session with a specialist to further discuss further details. In one embodiment, the live support button was not available in the presentation initially. Based on the analysis of the user interaction, analysis module 1702 may determine that the user may wish to have a live support session at a certain point in time. As a result, guided support identification system 1125 may cause remote device 1101 to present a live support control to the user, which may be in a form of a displayed button, a voice activated control, or a combination of both, to allow the user to initiate a live support session.

In response to the live support request, in one embodiment, case management module/touch plan engine 1205 is configured to receive a list of one or more recommended agents provided by guided support identification system 1125 and/or one or more preferred agents of the user retrieved from user agent preferences 1720. A list of the recommended agents and preferred agents is transmitted to remote device 1101. The list of the recommended agents and preferred agents is presented via a graphical user interface (GUI) displayed on a display of device 1101 to allow the user to select one of the recommended agents and preferred agents for the live support session. Note that the list of the recommended agents and preferred agents may also be transmitted by case management module/touch plan engine 1205. Case management module/touch plan engine 1205 and/or guided support identification system 1125 may also cause remote device 1101 to provide a list of communications options such as voice, chat, email, video, etc. to allow the user to select one or more of the choices to establish a live session with an agent or specialist. The list of communications options may be previously configured based on user preference and client preference.

In response to a user selection of an agent (e.g., system randomly assigned agent, user-selected preferred or recommended agent) and/or a communications option, according to one embodiment, case management module or touch plan engine 304 is configured to compile and generate routing context (e.g., touch plan) 1710 based on information from data warehouse 109, including user information, client information, product information, user interaction history, etc. Routing context 1710 is then provided to multi-channel communications and routing system 1108 to be routed to agent 1115, where routing context 1710 is presented to agent 1115 as part of a screen pop at a desktop of the agent, such that when agent 1115 communicates with the user of remote device 1101, agent 1115 has all the necessary information concerning the user and the product in question.

Furthermore, according to one embodiment, at a conclusion of the live support session, survey module 1705 is configured to transmit a survey to remote device 1101 to allow the user to provide a feedback, such as a rating, concerning quality of the selected agent. The feedback is utilized to update the ratings of the selected agent in general, as well as a rating of the agent as a preferred agent associated with the user. Such a rating may affect a subsequent selection of recommended agent candidates and preferred agent candidates.

According to one embodiment, while the user is navigating the presentation at remote device 1101, the user interaction with the presentation is periodically transmitted from remote device and received by analysis module 1702. Based on the user interaction, the support subject matter may be periodically determined and skill set 1703 may be determined or updated, which may override a previous one. The received user interaction may also be stored in a database of the service center as part of user interaction history. Thus, skill set 1703 may be same or different at any moment dependent upon the user interaction at the point in time. Further, skill set 1703 may or may not be utilized dependent upon whether the user ends up requesting a live support during the current user session. Thus, the determined skill set 1703 may only be utilized during a current user session (e.g., same browser session or same instant of an application). When the current user session ends, the determined skill set may be discarded. When a user initiates a new session, the above operations may be repeatedly performed and a new set of skills may be determined dependent upon the user interaction at the point in time.

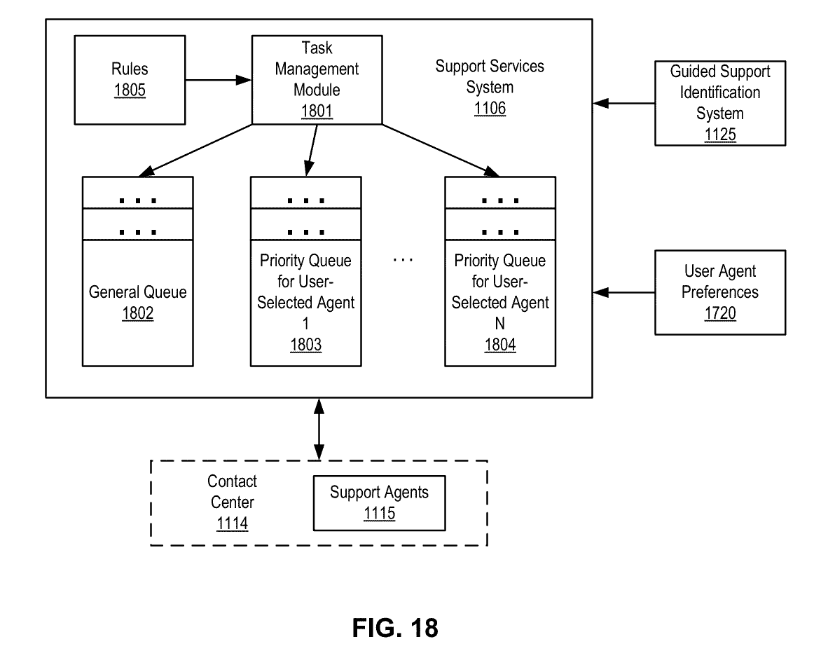

FIG. 18 is a block diagram illustrating a support service system of a service center according to another embodiment of the invention. Referring to FIG. 18, support services system 1106 includes task management module 1801 to manage pending support service requests in multiple queues 1802-1804. As described above, an agent selected for a live support session may be selected by a user (e.g., one of recommended agents and preferred agents) or by the system automatically (e.g., a randomly assigned agent). According to one embodiment, general queue 1802 is utilized to store pending support service requests in which a user does not select any of the recommended agents and/or preferred agent. In this situation, the system will put the pending request in general queue 1802 such that the request will be serviced when a next agent becomes available. Note that although the user does not select an agent, an agent assigned to the user may be identified and selected by the system such as the guided support identification system 1125 described above. In such a situation, the task of the selected agent is put in general queue 1802, where the task is handled on a first-come-first-served basis by a next available agent. Note that general queue 1802 may be the one associated with a particular subject matter or support type, or a particular skill set, which may be identified by the guided support identification system.

In addition, according to one embodiment, if the user actively selects an agent, either a preferred agent or a recommended agent, the task will be put into a priority queue, such as queues 1803-1804, which is specifically allocated for the selected agent. In one embodiment, the selected agent typically has to finish the support requests in the corresponding queue (e.g., queues 1803-1804) before taking on the tasks pending in general queue 1802. Alternatively, a selected agent may take on a task in general queue 1802 after serving every predetermined number of tasks in its priority queue. Such priority scheme may be configurable based on a set of rules 1805, which may be configured based on a variety of data, such as subject matters or support types, clients, products, skill sets, etc.

Referring back to FIG. 11, according to one embodiment, route sequence manager 1107 is configured to manage route sequence maps for a variety of users and/or a variety of clients. Route sequence manager 1107 may be implemented as part of self-support system 1121. Route sequence manager 1107 is to allow a user or an administrator to configure a route sequence map to help guiding a user to navigate resources available from a service center, such as, obtaining support services from a support service agent concerning a product or service provided by a client of the service center. A route sequence map is a collection of route sequences pulled together allowing a variety of operations to be performed via a service center and initiated from a single application such as application 1103 of client device 1101. A route sequence map can logically represent a global route context of a user that can lead to a variety of actions performed and/or one or more further route sequences of one or more related subject matters. Once a route sequence map has been configured via route sequence manager 1107 and stored in one of the databases 1110-1113, a user can initiate from application 1103 from device 1101 to navigate the preconfigured resources associated with the route sequence map available from service center 1102, without having to provide detailed information regarding how to access those resources at runtime.

According to one embodiment, route sequence manager 1107 of service center 1102 provides a configuration interface, such as an application programming interface (API) or a Web-based interface (e.g., Web portal) via a variety of communication protocols, which may be implemented as part of API 1104, to allow an end user or an administrator of a corporate client to configure and/or create a route sequence map for the end user or users associated with the corporate client (e.g., employees of a corporation and/or buyers of products associated with a retailer or manufacturer). A route sequence map can be utilized as a road or navigation map allowing a user navigating elements or nodes of the route sequence map to reach certain resources available from service center 1102 without requiring the user to specifically provide detailed information at runtime.

In one embodiment, a route sequence map includes various context elements or nodes arranged in a hierarchical structure. Each context element includes a property having one or more property values or attributes that can be used to specify one or more actions and/or one or more links to one or more other context elements (e.g., child context elements). A user or administrator can configure via a configuration interface of the service center to populate the property values of each context element. A context element can be one of an action context element and a navigation context element. An action context element can be configured such that when activated will cause the service center to perform an action using a method specified by one or more property values of the action context element. For example, an action context element can be configured to cause the service center to contact a particular person (e.g., friend or family member of a user, or a service support agent of the service center) using a particular communication method (e.g., voice, email, text, video, chat). As a result, when a user activates this action context element from an application such as a mobile phone application, service center 1102 can look up the property values of the corresponding action context element and to establish a communication session with a remote user associated with the action context element using a communication method specified by the action context element, without having the local user to provide the detailed information regarding how to reach the remote user at runtime.

A navigation context element can be configured, based on a variety of factors set forth above, that when activated, one or more related context elements can be identified that are related to the activated context element. During the configuration phase, a user can specify what other context elements (e.g., child context elements) are related to the current context element. The related context elements can include an action context element and/or another navigation context element that leads to one or more further context elements (e.g., grandchild context elements). For example, a context element “Finance” can be configured to be associated with one or more child context elements, such as “Chase,” “Bank of America,” and “Wells Fargo,” etc. In this way, a user can group or associate all of the financial institutes under the “Finance” context element and navigate each of the associated child context elements from there, without having to search and provide details for each of those entities. Alternatively, the “Finance” context element can be associated with a child action context element such as a “Call My Financial Advisor” context element that when activated will make a voice call to the specified finance advisor, which may be specified in one or more property values of the “Call My Financial Advisor” context element. As a result, the user does not have to provide detailed information on how to call its financial advisor at run time. The configured route sequence map can then be stored in a database of the service center, such as a user database and/or client database. Such a route sequence map can be retrieved subsequently by route sequence manager 1107 of service center 1102 in response to a request or command received from application 1103 running at remote device 1101 over a network.

According to one embodiment, application (also referred to as a navigation application) 1103 can be provided and installed at a device of a user, such as a mobile phone, laptop, desktop, or a Web-based application. When application 1103 is launched from client device 1101, application 1103 is to access service center 1102 over a network (e.g., Internet) for authenticating a user of the client device, for example, based on username and password of a user associated with client device 1101 and/or a unique device identifier (ID) of client device 1101. Once the user has been successfully authenticated by service center 1102, route sequence manager 1107 of service center 1102 retrieves a route sequence map from a user database and/or client database that has been previously configured and stored and transmits information representing the route sequence map to the client device to be presented at a display of client device 1101 by application 1103.

According to one embodiment, a route sequence map is displayed in multiple rows of graphical representations, each graphical representation corresponding to a context element of the route sequence map. An inner or lower row of the route sequence map represents a parent row to a child row displayed as an outer or upper row of the route sequence map. When a graphical representation of an inner or lower row is selected (e.g., highlighted), an ID of the selected graphical representation is transmitted by application 1103 of client device 1101 to service center 1102 over a network, which may be a local area network (LAN), a wide area network (e.g., Internet), or a combination thereof. Based on the ID, service center 1102 is to identify a selected context element of the route sequence map. If the selected context element is an action context element, service center 1102 is to perform an action that is specified in a property value of the selected context element using a method specified in a property value of the selected context element. If the selected context element is a navigation context element, route sequence manager 1107 of service center 1102 is to identify one or more child context elements associated with the selected context element and transmit the information of the child context elements to the client device. The client device 1101 is to display one or more graphical representations representing the one or more child context elements in an outer or upper row, while the selected graphical representation remains highlighted in the inner or lower row. As a result, the user can easily navigate context elements of the route sequence map via the application, without the hassles of managing the individual elements of the route sequence and their detailed settings.

In one embodiment, service center 1102 further includes a multi-channel communication and routing system (MCRS) 1108 to provide one or more communication channels to any user or client to concurrently access service center 1102. Examples of communication channels include email, chat, texting (e.g., SMS or MMS), voice (e.g., automated IVR, real-time, or VoIP), video, Web (e.g., Web conferencing), and/or online community forum (e.g., Facebook™ or Twitter™), or a combination thereof. Note that MCRS 1108 may be fully or partially integrated with service center 1102 or alternatively, it may be maintained or provided by a third party or partner (e.g., communicatively coupled via service API 1104 over a network). Service center 1102 further includes an automatic caller distribution (ACD) system (not shown) to receive, route, and manage voice calls exchanged via the multi-channel communication system. A customer can obtain support services from service center 1102 via a variety of communication mechanisms. A customer can initiate a support request to contact a live agent such as agents 1115 in a live manner. Alternatively, a customer may browse certain knowledgebase, such as KB 1113 via a Web interface, in an attempt to find a solution to a problem of a product he/she purchased from a manufacturer via a client of service center 1102.

According to one embodiment, application 1103 is installed on mobile device 1101 of a customer or user, where application 1103 can serve as a central service point or entry point to service center 1102 that provides support services to a variety of products or services provided by a variety of vendors. The vendors can be, for example, manufacturers, distributors, retailers, service brokers, purchasing houses, etc. of the products. Vendors may be the clients of service center 1102 or entities having a business relationship with service center 1102. A user (also referred to herein as a customer) can activate application 1103 from the user's mobile device 1101 to reach agents 1115 the service center 1102 or KB data center 1113 via a variety of communication channels or media, such as, for example, email, chat, voice (including automated interactive voice recognition or IVR, voice over Internet protocol or VoIP), video, Web, and/or online community-based forum, etc. Application 1103 can be a thin/thick client application or a Web-based application.

Note that a service center described throughout this application is not limited to a traditional service center or support center, nor is it implemented in a single physical location. A service center described herein represents a collection of service logic or providers communicatively coupled to each other over a network in a distributed or a cloud-based fashion. The term of a service center herein represents any kind of service providers that provide a variety of services to customers or users. As described throughout this application, a service center can be a set of enabling cloud-based service APIs, which enable a variety of consumer product services and support offerings via an intelligent set of technologies providing automated and/or live communications. In one embodiment, services provided by a service center can include, but not limited to: 1) user, product, and loyalty registration and support services; 2) product wish list, reviews, and comparisons; 3) purchasing and accessorizing services; 4) social community support and integration services; 5) intelligent knowledge support services; and 6) integrated sales and product disposition services, etc.

Also note that an agent, an expert, or a customer representative described throughout this application is not limited to a real person. The term of an agent, an expert, or a customer representative can also refer to any processing logic or functional block that is configured or programmed to provide automated services to a customer, for example, via the services APIs of the service center, without a need of a real person involved. Such processing logic and/or functional blocks can be implemented in software, hardware, or a combination thereof.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
receiving, at a server representing a support center, a user document from a client to be delivered to a user, wherein the user is a customer of the client and the user document contains information describing a product or service (product/service) provided by the client to the user, and wherein the support center provides support services to a plurality of products or services on behalf of a plurality of product/service providers as clients to the support center;
fabricating an interactive media document based on the user document, including embedding one or more controls in the interactive media document and adding additional information in the interactive media document based on information obtained from a backend system of the client, wherein the one or more controls, when activated from the interactive media, transmit a request to the support center for obtaining support services;
sending identifying information identifying the interactive media document to the user on behalf of the client over a network, without requiring the client to send the user document to the user, such that the user can access the interactive media document;
receiving, at the server, a request from the user for obtaining support services concerning content of the user document, wherein the request was originated from an activation of one of the controls embedded in the interactive media document when the interactive media document is displayed at a remote device associated with the user;
in response to the request, establishing a live communications session between the remote device representing the interactive media document and a support agent associated with the support center, including routing data between the user and the support agent via the interactive media document displayed at the remote device; and
monitoring and storing in a media journey repository metadata describing interactive events associated with the interactive media document.

2. The method of claim 1, wherein monitoring and storing in a media journey repository comprises:
recording in the media journey repository the additional information added into the interactive media document; and
recording in the media journey repository communications between the user and the support agent during the live communications session, wherein recorded metadata is stored in a storage location associated with the interactive media document.

3. The method of claim 2, wherein monitoring and storing in a media journey repository further comprises:
recording in the media journey repository when the interactive media document was sent to the user; and
recording in the media journey repository when the interactive media document was received by the user.

4. The method of claim 1, wherein fabricating an interactive media document based on the user document comprises:
performing an analysis on content of the user document, including extracting personal information of the user from the user document and determining a document type of the user document;
accessing the backend system of the client based on the personal information of the user to obtain additional user information of the user with respect to the client;
accessing the backend system of the client based on the document type to determine a set of one or more rules associated with the document type that have been configured by the client; and
generating the additional information to be added to the interactive media document based on the additional user information of the user and the set of one or more rules.

5. The method of claim 4, wherein sending identifying information identifying the interactive media document to the user comprises:
accessing the backend system of the client to determine prior relationship between the user and the client with respect to the product/service described in the user document;
determining a priority of the user document based on the analysis of the user document and the prior relationship between the user and the client, in view of the set of one or more rules of the client; and
in response to determining that the priority satisfies a predetermined condition, transmitting the interactive media document to the user via a guaranteed delivery mechanism in which an electronic receipt will be received from the user when the user receives the interactive media document.

6. The method of claim 1, wherein establishing a live communications session further comprises:
extracting a document identifier (ID) from the request for obtaining support services;
retrieving the interactive media document and associated metadata from the media journey repository based on the document ID;
accessing the backend system of the client based on the retrieved interactive media document to identify further user information, client information, and product/service information based on the retrieved interactive media document;
identifying and selecting from a support agent database the support agent having a required skill set based on the user information, client information, and product/service information; and
enabling the interactive media document, the metadata associated with the interactive media document, the user information, the client information, and the product/service information to be available at a desktop of the support agent during the live communications session.

7. The method of claim 1, wherein the live communications session is a chat session, wherein routing data between the user and the support agent via the interactive media document comprises:
receiving first chat content from the remote device of the user, wherein the first chat content is received from a first field displayed within the interactive media document and entered by the user, while content of the user document is being displayed concurrently;
routing the first chat content to the support agent to be displayed at the desktop of the support agent;
receiving second chat content from the desktop of the support agent that has been entered by the support agent; and
routing the second chat content to the remote device to be displayed in a second field within the interactive media document, without requiring the user to use a separate chat application.

8. The method of claim 1, further comprising:
receiving a second request originated from a first field displayed within the interactive media document while content of the user document is being displayed concurrently, the second request having a question entered by the user concerning content of the user document;
extracting a document identifier (ID) from the second request, the document ID identifying the interactive media document;
determining a subject matter of the question based on the document ID;
accessing a knowledgebase to retrieve one or m ore answers associated with the subject matter; and
transmitting the one or more answers to the remote device of the user to be displayed in a second field within the interactive media document, without requiring the user to separately access the knowledgebase via a separate application.

9. The method of claim 1, further comprising:
receiving a second request originated from a second control displayed within the interactive media document while content of the user document is being displayed concurrently, the second request requesting a history of a user account concerning the product/service associated with content of the user document;
extracting a document identifier (ID) from the second request, the document ID identifying the interactive media document;
accessing the backend system of the client to retrieve history data associated with the user concerning the product/service associated with the user document; and
transmitting the history data to the remote device to be displayed within the interactive media document.

10. A non-transitory machine-readable medium having instructions stored therein, which when executed by a machine, cause the machine to perform operations, the operations comprising:
receiving, at a server representing a support center, a user document from a client to be delivered to a user, wherein the user is a customer of the client and the user document contains information describing a product or service (product/service) provided by the client to the user, and wherein the support center provides support services to a plurality of products or services on behalf of a plurality of product/service providers as clients to the support center;
fabricating an interactive media document based on the user document, including embedding one or more controls in the interactive media document and adding additional information in the interactive media document based on information obtained from a backend system of the client, wherein the one or more controls, when activated from the interactive media, transmit a request to the support center for obtaining support services;
sending identifying information identifying the interactive media document to the user on behalf of the client over a network, without requiring the client to send the user document to the user, such that the user can access the interactive media document;
receiving, at the server, a request from the user for obtaining support services concerning content of the user document, wherein the request was originated from an activation of one of the controls embedded in the interactive media document when the interactive media document is displayed at a remote device associated with the user;
in response to the request, establishing a live communications session between the remote device representing the interactive media document and a support agent associated with the support center, including routing data between the user and the support agent via the interactive media document displayed at the remote device; and
monitoring and storing in a media journey repository metadata describing interactive events associated with the interactive media document.

11. The non-transitory machine-readable medium of claim 10, wherein monitoring and storing in a media journey repository comprises:
recording in the media journey repository the additional information added into the interactive media document; and
recording in the media journey repository communications between the user and the support agent during the live communications session, wherein recorded metadata is stored in a storage location associated with the interactive media document.

12. The non-transitory machine-readable medium of claim 11, wherein monitoring and storing in a media journey repository further comprises:
recording in the media journey repository when the interactive media document was sent to the user; and
recording in the media journey repository when the interactive media document was received by the user.

13. The non-transitory machine-readable medium of claim 10, wherein fabricating an interactive media document based on the user document comprises:
performing an analysis on content of the user document, including extracting personal information of the user from the user document and determining a document type of the user document;
accessing the backend system of the client based on the personal information of the user to obtain additional user information of the user with respect to the client;
accessing the backend system of the client based on the document type to determine a set of one or more rules associated with the document type that have been configured by the client; and
generating the additional information to be added to the interactive media document based on the additional user information of the user and the set of one or more rules.

14. The non-transitory machine-readable medium of claim 13, wherein sending identifying information identifying the interactive media document to the user comprises:
accessing the backend system of the client to determine prior relationship between the user and the client with respect to the product/service described in the user document;
determining a priority of the user document based on the analysis of the user document and the prior relationship between the user and the client, in view of the set of one or more rules of the client; and
in response to determining that the priority satisfies a predetermined condition, transmitting the interactive media document to the user via a guaranteed delivery mechanism in which an electronic receipt will be received from the user when the user receives the interactive media document.

15. The non-transitory machine-readable medium of claim 10, wherein establishing a live communications session further comprises:
extracting a document identifier (ID) from the request for obtaining support services;
retrieving the interactive media document and associated metadata from the media journey repository based on the document ID;
accessing the backend system of the client based on the retrieved interactive media document to identify further user information, client information, and product/service information based on the retrieved interactive media document;
identifying and selecting from a support agent database the support agent having a required skill set based on the user information, client information, and product/service information; and
enabling the interactive media document, the metadata associated with the interactive media document, the user information, the client information, and the product/service information to be available at a desktop of the support agent during the live communications session.

16. A system representing a support center, comprising:
a media fabrication module to receive a user document from a client to be delivered to a user, wherein the user is a customer of the client and the user document contains information describing a product or service (product/service) provided by the client to the user, and wherein the support center provides support services to a plurality of products or services on behalf of a plurality of product/service providers as clients to the support center, to fabricate an interactive media document based on the user document, including embedding one or more controls in the interactive media document and adding additional information in the interactive media document based on information obtained from a backend system of the client, wherein the one or more controls, when activated from the interactive media, transmit a request to the support center for obtaining support services;
a media delivery module to send identifying information identifying the interactive media document to the user on behalf of the client over a network, without requiring the client to send the user document to the user, such that the user can access the interactive media document;
a support service system to receive a request from the user for obtaining support services concerning content of the user document, wherein the request was originated from an activation of one of the controls embedded in the interactive media document when the interactive media document is displayed at a remote device associated with the user;
a multi-channel communications system, in response to the request, to establish a live communications session between the remote device representing the interactive media document and a support agent associated with the support center, including routing data between the user and the support agent via the interactive media document displayed at the remote device; and
a media journey repository to store metadata describing interactive events associated with the interactive media document.

17. The system of claim 16, wherein the media journey repository is configured to
record in the media journey repository the additional information added into the interactive media document, and
record in the media journey repository communications between the user and the support agent during the live communications session, wherein recorded metadata is stored in a storage location associated with the interactive media document.

18. The system of claim 17, wherein the media journey repository is configured to
record in the media journey repository when the interactive media document was sent to the user, and
record in the media journey repository when the interactive media document was received by the user.

19. The system of claim 16, wherein the fabrication module is configured to:
perform an analysis on content of the user document, including extracting personal information of the user from the user document and determining a document type of the user document,
access the backend system of the client based on the personal information of the user to obtain additional user information of the user with respect to the client,
access the backend system of the client based on the document type to determine a set of one or more rules associated with the document type that have been configured by the client, and
generate the additional information to be added to the interactive media document based on the additional user information of the user and the set of one or more rules.

20. The system of claim 19, wherein the media delivery module is configured to:
access the backend system of the client to determine prior relationship between the user and the client with respect to the product/service described in the user document,
determine a priority of the user document based on the analysis of the user document and the prior relationship between the user and the client, in view of the set of one or more rules of the client, and
in response to determining that the priority satisfies a predetermined condition, transmit the interactive media document to the user via a guaranteed delivery mechanism in which an electronic receipt will be received from the user when the user receives the interactive media document.

21. The system of claim 16, wherein the support services system is configured to:
extract a document identifier (ID) from the request for obtaining support services,
retrieve the interactive media document and associated metadata from the media journey repository based on the document ID,
access the backend system of the client based on the retrieved interactive media document to identify further user information, client information, and product/service information based on the retrieved interactive media document;
identify and select from a support agent database the support agent having a required skill set based on the user information, client information, and product/service information, and
enable the interactive media document, the metadata associated with the interactive media document, the user information, the client information, and the product/service information to be available at a desktop of the support agent during the live communications session.

22. A computer-implemented method, comprising:
receiving, at a server representing a support center, a sample user document from a client representing an example of user documents to be sent to a plurality of users who are customers of the client, wherein the support center provides support services to a plurality of products and/or services (products/services) on behalf of a plurality of product/service providers as clients to the support center; and
providing an authoring user interface to allow an administrator of the client to author an interactive media document template based on the sample user document, including
displaying the sample user document in a first display area of a graphical user interface (GUI),
displaying a plurality of controls in a second display area of the GUI, wherein each of the controls, when activated, is configured to contact the support center for obtaining support services concerning content of a user document as part of an interactive media document to be generated from the interactive media document template,
in response to a user selection of one or more of the displayed controls, displaying the selected one or more controls in the first display area to be associated with the sample user document, and
generating the interactive media document template for the client by compiling the selected one or more controls and the sample user document displayed in the first display area of the GUI.

23. The method of claim 22, wherein the sample user document is replaceable by an actual user document of an actual customer of the client when an actual interactive media document of the actual customer is subsequently generated.

24. The method of claim 22, further comprising:
receiving a plurality of user documents from the client, the user documents being associated with a plurality of users who are customers of the client;
generating a plurality of interactive media documents based on the plurality of user documents, respectively, using the interactive media document template; and
transmitting the plurality of the interactive media documents to the plurality of users on behalf of the client, respectively, without requiring the client to send the user documents to the users.

25. The method of claim 22, wherein the plurality of controls comprises a first control, which when activated, is configured to initiate a voice connection over a network with a support agent associated with the support center from an interactive media document that is generated based on the interactive media document template.
